(19) United States
(12) Patent Application Publication
(10) Pub. No.: US 2008/0244229 A1
(43) Pub. Date: Oct. 2, 2008

(54) Information processing apparatus

(76) Inventors: Hiroshi Yao, Kanagawa (JP); Kenichiro Yoshii, Tokyo (JP); Tatsunori Kanai, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/898,880

(22) Filed: Sep. 17, 2007

(30) Foreign Application Priority Data
Mar. 29, 2007 (JP) 2007-087388

(51) Int. Cl. G06F 9/30

(52) U.S. Cl. 712/205; 712/E09.016

(57) ABSTRACT

In an information processing apparatus, a fetch to a storage address of a first storage unit which stores a first instruction executed at first within a plurality of instructions that is included in a software and executed when a processor starts the software via the channel is detected. It is detected that the processor executed a specific instruction within the plurality of instructions via the channel. It is determined whether a predetermined time has passed since the detection of the fetch to the storage address until the detection of the execution of the specific instruction. When it is determined that the predetermined time has not passed, it is determined whether an interrupt to the processor is prohibited based on a result of the processor executing the specific instruction, and an access is released to the process according to a result of determination.

### CROSS-REFERENCE TO RELATED APPLICATIONS

This application is based upon and claims the benefit of priority from the prior Japanese Patent Application No. 2007-087388, filed on Mar. 29, 2007; the entire contents of which are incorporated herein by reference.

### BACKGROUND OF THE INVENTION

1. Field of the Invention

The present invention relates to information processing apparatus with a software installed therein.

2. Description of the Related Art

From the past, reliability and security have been emphasized in a database system and a server machine (general-purpose computer) that executes a mission-critical processing, from various factors such as the importance of the processing and the degree of secrecy of internally-stored data. However, in recent years, it has been extremely important to secure the reliability and the security not just for the general-purpose computer but also for various equipments such as embedded systems.

In the field of the embedded systems, a number of functions are simultaneously executed in a single device, or a function is added by downloading a new function, so that the functions are being complicated. In a development or an operation of such device that is capable of executing a plurality of functions, there is a new type of problem compared with a device having a single function.

For example, in a case where a certain function has a trouble, the whole device may hang up even though it is a small portion of the entire functions. In addition, in a case where a function downloaded and added to a device is a malice program, a piece of information or a program of which confidentiality should be preserved may be leaked to the outside or be damaged or undesirably altered. Thus, the reliability and the security have become a critical problem even for the embedded systems.

To solve the above problems, it is required to control an access to a resource that is allocated to a program that implements each function. Examples of the access control include a prohibition of an access to a resource that is allocated to a specific program from other programs or functions, exclusive control and management of an access to a resource shared by a plurality of functions or programs, and the like. Furthermore, it is necessary to protect an access control mechanism and the control information itself from being freely operated by others.

As a method of realizing the protection and enhancing the reliability and the security by separating a plurality of functions, a virtualization technology for the computer has been proposed. There are various schemes to implement the virtualization technology. As an example of the virtualization technology, there is a scheme in which a virtualization layer is provided between a hardware and an operating system (OS) and a plurality of operating systems (guest OS) is run on the virtualization layer. This virtualization layer is generally referred to as a hypervisor layer. The hypervisor layer manages a resource, such as a memory, a device, and an interrupt, and provides a virtual machine configured with resources allocated to each guest OS. With this scheme, an execution of a plurality of guest OS's can be realized without being interfered with each other in a separated manner. When the function of the hypervisor layer is implemented by a software, the software is referred to as a hypervisor.

In a processor used in the general-purpose computer, a hardware mechanism that supports the virtualization is prepared in the processor itself. As an example, there is a technology advocated by the Intel (Registered Trademark), which is described in “Intel® Virtualization Technology Specification for the IA-32 Intel(R) Architecture”, [online], [Retrieved on May 31, 2005], Internet <URL: ftp://download.intel.com/technology/computing/vptech/C97063-002.pdf>. In a processor in which the above technology is implemented, a number of privilege modes indicating a privilege of a program under running are prepared, and it is possible to make a setting to shift to a higher privilege mode when executing a specific instruction. This will cause an access to a shared resource from a guest OS is monitored by a hardware, so that, at the time of accessing the shard resource, a software to which a higher privilege mode is granted is capable of checking the contents of the access.

As another example, there is a technology called the “Pacifica” advocated by the Advanced Micro Devices Inc. In the processor in which the Pacifica is implemented, a mechanism that intercepts an interrupt and a function to generate a virtual interrupt from a software are prepared. With this scheme, it is possible to intercept the interrupt at the hypervisor, and then to manage a delivery of the interrupt to a guest OS that requires the interrupt. In addition, a mechanism is prepared that monitors an access to an address translation table from a guest OS. With this scheme, it is possible to prevent a guest OS from accessing a memory area that is allocated to the other guest OS by freely rewriting an address translation table.

However, unlike a high performance processor such as the one used in the general-purpose computer, a commonly used embedded processor core does not have a mechanism that supports the virtualization. In general, this type of processor has a fewer privilege modes, so that, when the processor executes a plurality of guest OS's, each of the guest OS's operates in the uppermost privilege mode. Therefore, there is a problem that an arbitrary guest OS is capable of illegally referring and altering a memory area or a device allocated to the other guest OS. In addition, because the processor does not have a mechanism to protect an interrupt vector table for managing an interrupt, there is no guarantee that a hypervisor can perform an intercept and a delivery of the interrupt in a convincing way.

### SUMMARY OF THE INVENTION

According to one aspect of the present invention, an information processing apparatus includes a processor; a first storing unit configured to store a first software that causes the processor to access a first access range; a second storing unit configured to store a second software that causes the processor to access a second access range that is narrower than the first access range; a channel configured to connect the first storing unit and the processor, and perform a communication of data required for the processor to execute the first software; a fetch detecting unit configured to detect a fetch to a storage address of the first storage unit which stores a first instruction executed at first within a plurality of instructions that is included in the first software and executed when the processor starts the first software via the channel; an execution detecting unit configured to detect that a specific instruction within the plurality of instructions is executed by the processor via the channel; a time determining unit configured to determine whether a predetermined time has passed since the fetch detecting unit detects the fetch to the storage address until the execution detecting unit detects the execution of the specific instruction, when the processor is executing the first software; an execution determining unit configured to determine whether an interrupt to the processor is prohibited based on a result of executing the specific instruction by the processor, when the time determining unit determines that the predetermined time has not passed; and a control unit configured to release an access to the first access range to the processor, when the execution determining unit determines that an interrupt to the processor is prohibited.

According to another aspect of the present invention, an information processing apparatus includes a processor; a first storing unit configured to store a first software that causes the processor to access a first access range; a second storing unit configured to store a second software that causes the processor to access a second access range that is narrower than the first access range; a channel configured to connect the first storing unit and the processor, and perform a communication of data required for the processor to execute the first software; a first fetch detecting unit configured to detect a fetch to a first storage address of the first storage unit which stores a first instruction executed at first within a plurality of instructions that is included in the first software and executed when the processor starts the first software via the channel; a second fetch detecting unit configured to detect a fetch to a second storage address of the first storage unit which stores a specific instruction within a plurality of instructions that is included in the first software and executed when the processor starts the first software via the channel; a time determining unit configured to determine whether a predetermined time has passed since the first fetch detecting unit detects the fetch to the first storage address until the second fetch detecting unit detects the fetch to the second storage address, when the processor is executing the first software; and a control unit configured to release an access to the first access range to the processor, when the time determining unit determines that the predetermined time has not passed.

According to still another aspect of the present invention, an information processing apparatus includes a processor; a first storing unit configured to store a first software that causes the processor to access a first access range; a second storing unit configured to store a second software that causes the processor to access a second access range that is narrower than the first access range; a channel configured to connect the first storing unit and the processor, and perform a communication of data required for the processor to execute the first software; a fetch detecting unit configured to detect a fetch to a plurality of instructions that is included in the first software and executed when the processor starts the first software via the channel; a fetch determining unit configured to determine whether a fetch to each storage address which stores each instruction constituting the plurality of instructions is performed in an order of the instructions from an address of a detected fetch destination, when the processor is executing the first software; an execution detecting unit configured to detect that a specific instruction within the plurality of instructions is executed by the processor, when the fetch determining unit determines that the fetch of the plurality of instructions has performed in the order of the instructions; a determining unit configured to determine whether the processor is in an interrupt disabled status from a result of executing the plurality of instructions detected; and a control unit configured to release an access to the first access range to the processor, when the execution determining unit determines that an interrupt to the processor is prohibited.

According to still another aspect of the present invention, an information processing apparatus includes a processor; a first storing unit configured to store a first software that causes the processor to access a first access range; a second storing unit configured to store a second software that causes the processor to access a second access range that is narrower than the first access range; a channel configured to connect the first storing unit and the processor, and perform a communication of data required for the processor to execute the first software; a fetch detecting unit configured to detect a fetch to a plurality of instructions that is included in the first software and executed when the processor starts the first software via the channel; a fetch determining unit configured to determine whether a fetch to each storage address which stores each instruction constituting the plurality of instructions is performed in an order of the instructions from an address of a detected fetch destination, when the processor is executing the first software; and a control unit configured to release an access to the first access range to the processor, when the fetch determining unit determines that the fetch of the plurality of instructions has performed in the order of the instructions.

### BRIEF DESCRIPTION OF THE DRAWINGS

FIG. 1 is a block diagram illustrating a configuration of a system LSI according to a first embodiment;

FIG. 2 is a schematic diagram illustrating an example of a binary code of an HV code included in the system LSI according to the first embodiment;

FIG. 3 is a schematic diagram illustrating an example of a binary code of an HV code included in the system LSI according to another embodiment;

FIG. 4 is a schematic diagram illustrating a first example in which an execution is transferred to a software code that performs an illegal processing in process of executing an entry field formed with a plurality of instructions of a hypervisor on a conventional system LSI;

FIG. 5 is a schematic diagram illustrating an example of a software configuration of the system LSI according to the first embodiment;

FIG. 6 is a flowchart for explaining a processing procedure for controlling an access to an HV protection area by switching operation modes according to a status of execution of the HV code in the system LSI according to the first embodiment;

FIG. 7 is a flowchart for explaining a processing procedure for confirming an appropriate execution of an entry field of the HV code in an operation-mode management circuit in the system LSI according to the first embodiment;

FIG. 8 is a flowchart for explaining a processing procedure for detecting an HV mode exit of the operation-mode management circuit in the system LSI according to the first embodiment;

FIG. 9 is a block diagram illustrating a configuration of a system LSI according to a second embodiment;

FIG. 10 is a schematic diagram illustrating an example of a binary code of an HV code included in the system LSI according to the second embodiment;

FIG. 11 is a schematic diagram illustrating an example of a binary code of an HV code included in the system LSI according to another embodiment;

FIG. 12 is a flowchart for explaining a processing procedure for confirming an appropriate execution of an entry field of the HV code in an operation-mode management circuit in the system LSI according to the second embodiment;

FIG. 13 is a block diagram illustrating a configuration of a system LSI according to a third embodiment;

FIG. 14 is a schematic diagram illustrating a second example in which an execution is transferred to a software code that performs an illegal processing in process of executing an entry field configured with a plurality of instructions of a hypervisor on the conventional system LSI;

FIG. 15 is a flowchart for explaining a processing procedure for confirming an appropriate execution of an entry field of the HV code in an operation-mode management circuit in the system LSI according to the third embodiment;

FIG. 16 is a flowchart for explaining a processing procedure for confirming an appropriate execution of an entry field of the HV code in an operation-mode management circuit in the system LSI according to a modification of the third embodiment;

FIG. 17 is a block diagram illustrating a configuration of a system LSI according to a fourth embodiment;

FIG. 18 is a flowchart for explaining a processing procedure for confirming an appropriate execution of an entry field of the HV code in an operation-mode management circuit in the system LSI according to the fourth embodiment;

FIG. 19 is a block diagram illustrating a configuration of a system LSI according to a fifth embodiment;

FIG. 20 is a schematic diagram illustrating a third example in which an execution is transferred to a software code that performs an illegal processing in process of executing an entry field formed with a plurality of instructions of a hypervisor on the conventional system LSI;

FIG. 21 is a flowchart for explaining a processing procedure for confirming an appropriate execution of an entry field of the HV code in an operation-mode management circuit in the system LSI according to the fifth embodiment;

FIG. 22 is a block diagram illustrating a configuration of a system LSI according to a sixth embodiment;

FIG. 23 is a flowchart for explaining a processing procedure for confirming an appropriate execution of an entry field of the HV code in an operation-mode management circuit in the system LSI according to the sixth embodiment;

FIG. 24 is a schematic diagram illustrating an example in which an execution is transferred to a software code that performs an illegal processing in process of executing an entry field formed with a plurality of instructions of a hypervisor on a conventional system LSI including a processor that simultaneously fetches a plurality of instructions;

FIG. 25 is a schematic diagram illustrating an example of an HV code in which each of the instructions in the entry field shown in FIG. 2 is arranged to prevent a falsification in a case where a instruction fetch unit is for every two instructions;

FIG. 26 is a schematic diagram for explaining a time relation between a instruction fetch and an execution in a case where a processor has a prefetch function;

FIG. 27 is a schematic diagram illustrating an example of an HV code that is capable of guaranteeing an interrupt-disabled status even when there is a fetch request from a processor with the prefetch function; and

FIG. 28 is a schematic diagram illustrating an example of an HV code that is capable of guaranteeing an interrupt-disabled status even when there is a fetch request of two instructions from a processor with the prefetch function.

### DETAILED DESCRIPTION OF THE INVENTION

Exemplary embodiments of an information processing apparatus according to the present invention are explained in detail below with reference to the accompanying drawings. In the embodiments, an example is explained in which the information processing apparatus is applied to a system LSI. However, the information processing apparatus can be applied not just for the system LSI but also for any type of device.

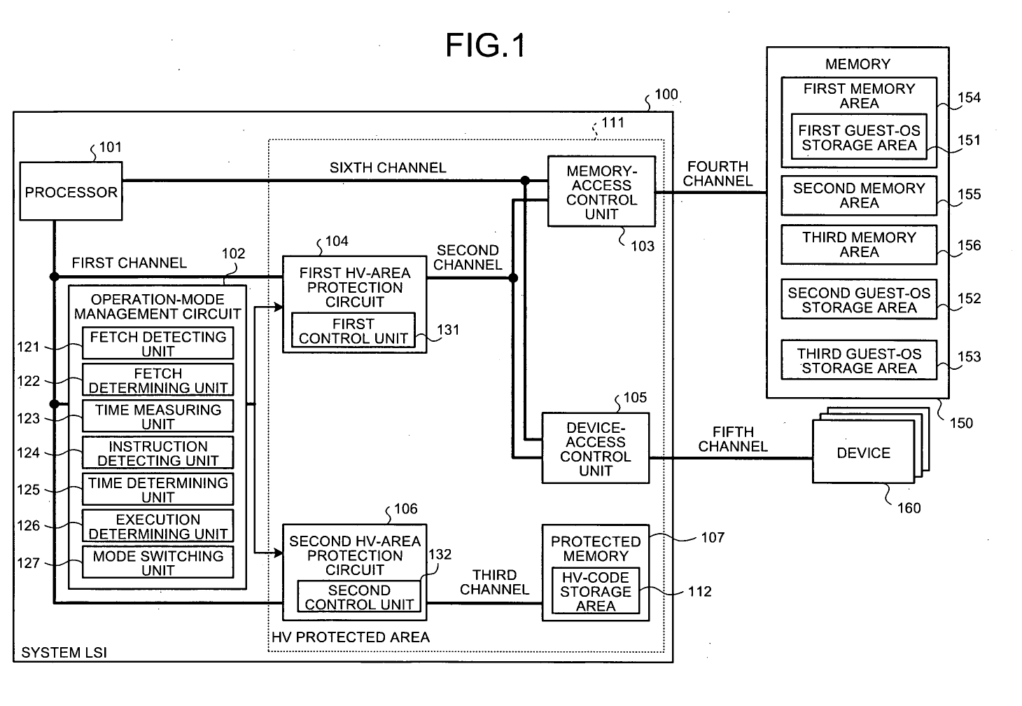

As shown in FIG. 1, a system LSI 100 according to a first embodiment is connected to a memory 150 and a device 160. The system LSI 100 includes a processor 101, an operation-mode management circuit 102, a memory-access control unit 103, a first HV (Hyper Viser)-area protection circuit 104, a device-access control unit 105, a second HV-area protection circuit 106, and a protection memory 107.

The memory 150 includes a first memory area 154, a second memory area 155, a third memory area 156, a second guest-OS storage area 152, and a third guest-OS storage area 153. The first memory area 154 includes a first guest-OS storage area 151.

A binary code of a first guest OS is stored in the first guest-OS storage area 151, a binary code of a second guest OS is stored in the second guest-OS storage area 152, and a binary code of a third guest OS is stored in the third guest-OS storage area 153. The first memory area 154, the second memory area 155, and the third memory area 156 are memory areas for which reading and writing are restricted by the memory-access control unit 103. The area in which the guest OS is stored can be secured inside a memory area for which reading and writing are restricted, such as the first guest-OS storage area 151.

The device 160 is connected to the system LSI 100, which is a device for which a control is performed by the processor 101 included in the system LSI 100. An access to the device 160 is restricted by the device-access control unit 105 that will be described later. The device 160 can be provided inside the system LSI.100 or outside the system LSI 100. The number of devices to be connected to the system LSI 100 is not specifically limited.

Examples of the device 160 include a memory module, an external mass storage device such as a hard disk drive, an external communication device such as a network interface, an input device used by a user to input information, such as a keyboard and a mouse, and an external output device such as a display; however, it is not limited to the above examples.

A first to a sixth channel are arranged in the system LSI 100 according to the first embodiment. These channels are media for transmitting data between the processor 101 and the memory, the device, and the like. At least an address of an access destination and data to be read or written are transmitted via the channels. Types of the channels can take any kind of scheme, and the first embodiment employs a bus. Examples of the bus include an address bus by the bit width of the address and a bus configured with a signal line indicating reading and writing. In addition, as another embodiment, the bus can be configured with a few signal lines without distinguishing between address and data, such as a serial bus, and an access request from a processor and a response from a memory can be transmitted on the signal lines by a predetermined protocol.

In the system LSI 100 according to the first embodiment, in a case where a privilege software is run on the processor 101, a setting is performed in such a manner that the privilege software works in a top-level operation mode managed by the system LSI 100. Then, a predetermined access to an HV protection area is released only in the top-level operation mode.

The privilege software refers to a software that is truly reliable from among the softwares working on the system LSI 100. A mechanism for guaranteeing the reliability of the privilege software can be realized in any kind of method. According to the first embodiment, the reliability of the privilege software is guaranteed by storing it in the protection memory 107 for which reading and writing are restricted. The first embodiment employs a hypervisor as an example of the privilege software. In the hypervisor, all access destinations included in the HV protection area becomes an access range. A binary code of the hypervisor is referred to as “an HV code”, and the above top-level operation mode is referred to as “an HV mode”.

An HV-code storage area 112 stores therein the HV code. The HV code stored in the HV-code storage area 112 should not be altered from a software of the guest OS and the like. Details on the HV-code storage area 112 will be described later.

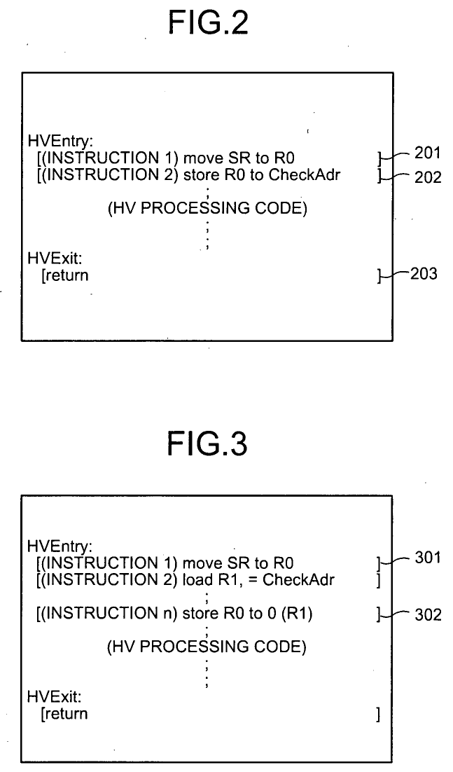

As shown in FIG. 2, the HV code includes a instruction 1 “move SR to R0” 201 and a instruction 2 “store R0 to CheckAdr” 202 in the entry field and “return” 203 as an exit code. With this entry field, the processor 101 executes a process of performing a confirmation of an interrupt disabled status to prevent other programs from interrupting at the time of executing the HV code. The entry field is configured with a plurality of instructions stored in the HV code, which is executed when the processor 101 starts the hypervisor. If the interrupt disabled is confirmed, a safety is guaranteed when the processor 101 executes the HV code.

As shown in FIG. 2, the entry field of the HV code is configured with a move instruction and a store instruction. Each of the instructions corresponds to a single instruction in a machine language provided by the processor 101. The “SR” in the instruction 1 indicates a register in which a value representing a status of the processor 101 (a status register). Information indicating whether the processor 101 is in an interrupt-disabled status is included in the value of the “SR”. The “R0” is a general-purpose register.

The reason why the entry field is configured with a plurality of instructions in the first embodiment is because there is no instruction for writing contents of the “SR” in a memory in a instruction set of the processor 101 so that the contents of the “SR” can only be transferred to the general-purpose register (R0).

Therefore, the entry field according to the first embodiment transfers the contents of the “SR” in which a value indicating the status of the processor 101 to the general-purpose register “R0” in the instruction 1. Furthermore, in the instruction 2, the entry field writes contents of the general-purpose register “R0” in CheckAdr. With the two instructions, it is possible to check that the processor 101 is in the interrupt-disabled status.

The “CheckAdr” in the instruction 2 is an address for writing a value of the “SR”. The “CheckAdr” is different from addresses of a memory and a device that are controlled by the processor 101. It is preferable to select an address that does not actually exist. In this case, although the processor 101 transmits an access request to the address “CheckAdr” that does not exist with respect to the channels, the memory and the device connected via the channels does not perform actual reading and writing in response to the access request.

Furthermore, even when selecting an address that actually exists for the “CheckAdr”, an address should be selected which is not used by the hypervisor and any other programs including the guest OS. If there is a device at the address indicated by the “CheckAdr”, a process of writing data will be performed by the instruction. As a result, it may cause a malfunction of the device. Therefore, it is necessary to take heed not to select an address that is actually used.

In addition, although it is different from the first embodiment, the entry field of the HV code can be configured with more than two instructions. As shown in FIG. 3, a case can be considered where the entry field of the HV code is configured with n pieces of instructions. The example shown in FIG. 3 shows a case where it is necessary to designate an address using another base register when writing a value of the general-purpose register in a memory. In this case, the contents of the status register “SR” is transferred to the general-purpose register “R0” in the instruction 1, a value of “R1” is set to the CheckAdr in the instruction 2, and the contents of the general-purpose register “R0” is written in the CheckAdr in the last instruction n using the “R1” as the base register. After executing these instructions, it is checked that the processor is in the interrupt-disabled status. Even when the entry field is configured with n pieces of instructions as described above, it is much more likely that the process is interrupted by other codes in the middle of the process.

Namely, in a case where the entry field of the HV code is configured with a plurality of instructions, it becomes a challenge how to preserve a security.

In the following, an example is explained in which an illegal user code other than the hypervisor is executed in the top-level operation mode in a conventional embedded system due to a design that simply sets the top-level operation mode when the hypervisor is operating.

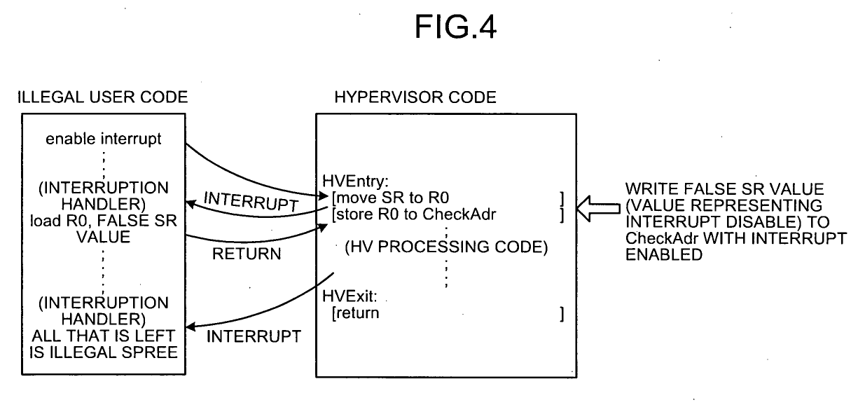

As shown in FIG. 4, an illegal user code on the left side is a software code that performs an illegal process, and a binary code on the right side is a binary code of the hypervisor (HV code). First, an interrupt is set to be enabled by “enable interrupt” in the software that performs the illegal process. After that, the illegal user code makes a jump to the instruction 1 of the entry field. After the instruction 1 is executed, the illegal user code generates some sort of interrupt, and an interrupt handler of the illegal user code causes a value of a false “SR” to be loaded to the “R0”, and then the illegal user code returns to the instruction 2 of the entry field. At the same time, the operation mode is changed to the top-level operation mode.

A range of instructions that is simultaneously read out with a single time of instruction fetch (hereinafter, “a instruction fetch unit”) varies depending on the processor. The instruction fetch unit is defined by the number of instructions simultaneously read out with a single time of instruction fetch and a boundary of a heading address of the instruction fetch unit. For example, in a PowerPC (Registered Trademark) 405 embedded processor core, a instruction length is 32 bits; however, when fetching a instruction from a memory connected to an onchip bus, two instructions arranged at a 64-bit boundary (=two-instruction boundary) are simultaneously read out with a single time of instruction fetch.

In the example of the PowerPC (Registered Trademark) 405 embedded processor core, in a case where the instructions are sequentially executed from the first instruction (i.e., a instruction arranged at the 64-bit boundary) from among the instructions included in the instruction fetch unit, an address designated in a instruction fetch request becomes the heading address of the instruction fetch unit, and two instructions included in the instruction fetch unit are simultaneously read out. When the first instruction is executed, the second instruction is stored in a buffer, and when the second instruction is executed, a instruction fetch with respect to the instruction does not occur.

According to the first embodiment, the instruction fetch unit is considered to be every single instruction. However, it can also be applied to a case where the instruction fetch unit is a plurality of instructions by replacing a “instruction” in the following explanation with a “instruction fetch unit”.

After executing the instructions in the entry field of the hypervisor, the processor 101 executes other instructions of the hypervisor. At the time of executing the hypervisor, because the interrupt is not actually disabled, the illegal user code can make an interrupt with respect to the hypervisor.

The example shown in FIG. 4 shows a case where the instructions in the entry field are executed in the order of instructions. Even though a fetch detecting unit 121 confirmed that the instructions are fetched in the order of instructions from the first to the last of the entry field of the hypervisor, the system LSI 100 according to the first embodiment cannot confirm a instruction fetch via the first channel. Therefore, even if a instruction fetch of a third user code is performed via the sixth channel, for example, the operation-mode management circuit 102 cannot detect the instruction fetch of the third user code. According to the first embodiment, it is determined whether an interrupt has been performed, by measuring a time required for the process of the entry field.

If an interrupt vector table and an interrupt processing routine can be protected in a full extent like a processor used in a general-purpose computer, a description to return to the HV code can prevent a problem from occurring even though a jump is made to the interrupt processing routine. However, in a processor used in an embedded system, it is not possible to put the interrupt vector table and the interrupt processing routine under the protection of the hypervisor. Therefore, there is a possibility that an illegal user code is executed in the top-level operation mode when an interrupt occurs.

Therefore, according to the first embodiment, the operation-mode management circuit 102, the first HV-area protection circuit 104, and the second HV-area protection circuit 106 performs a control in such a manner that the illegal user code does not work in the top-level operation mode.

Referring back to FIG. 1, the processor 101 performs a processing or an operation according to an OS such as the first guest OS and a software such as the hypervisor. Although the processor 101 according to the first embodiment is assumed to be a process having no built-in function for supporting the virtualization, it goes without saying that it can be a processor having a built-in function supporting the virtualization in practice.

The processor 101 reads out instructions sequentially from the memory (the memory 150 and the protection memory 107), and executes the instructions. In addition, the processor 101 performs reading and writing data with respect to memories and devices connected to each of the channels in response to the instructions.

However, in a common processor, a shift to an upper-level privilege mode is performed by executing a specific instruction represented by a system call instruction. After the system call instruction is executed, a shift to the privilege mode is performed. At the same time, an exception occurs, which makes a jump to a kernel code of the OS to set the interrupt disabled state, so that a safety is secured. The processor 101 according to the first embodiment is assumed to have a few operation modes including only a user mode to be allocated to an application and a privilege mode to be allocated to the OS. In this case, there is no operation mode to be allocated to the hypervisor, and it is not possible to distinguish between operations of the OS and the hypervisor.

Therefore, according to the first embodiment, the HV mode is introduced, which is an operation mode having an upper-level access right than the operation mode of the processor 101 itself. A switch to the HV mode is performed in a hardware provided outside the processor 101. In this case, because a jump to the HV code and a shift to the interrupt-disabled status by an instruction from a software working on the processor 101 are operations inside the processor, it is not possible to control them from the hardware provided on the outside.

In the processor 101 according to the first embodiment, the jump to the HV code and the shift to the interrupt-disabled status are left to the software working on the processor 101 (for example, the first guest OS and the like), and it is checked whether the jump is properly made to the HV code and whether the shift is properly made to the interrupt-disabled status in the hardware outside the processor 101. Regarding the operation-mode management circuit 102 that performs such check, an explanation will be given later.

The operation-mode management circuit 102 includes the fetch detecting unit 121, a fetch determining unit 122, a time measuring unit 123, a instruction detecting unit 124, a time determining unit 125, an execution determining unit 126, and a mode switching unit 127. The operation-mode management circuit 102 monitors data flowing on the first channel that connects the processor 101 and the second HV-area protection circuit 106, and performs a switching of the operation modes as appropriate.

The operation-mode management circuit 102 is a status shift circuit having at least two statuses including the HV mode and a normal mode as the operation mode. The operation-mode management circuit 102 monitors a signal flowing on the first channel, and performs a status shift between the HV mode and the normal mode if a predetermined condition is satisfied. Furthermore, the operation-mode management circuit 102 outputs a mode information signal to the first HV-area protection circuit 104 and the second HV-area protection circuit 106 in accordance with statuses of the HV mode and the normal mode. With this scheme, the first HV-area protection circuit 104 and the second HV-area protection circuit 106 can perform an access control in accordance with the operation mode. Details on the operation-mode management circuit 102 will be described later.

The predetermined condition for shifting to the HV mode is explained below. From the above description, it is assumed that a process required for the operation-mode management circuit 102 to switch the operation mode to the HV mode includes a process to properly shift an execution to the entry field of the HV code (i.e., it is required to guarantee that the instructions of the entry field have been properly executed) and a process to set the interrupt-disabled status (i.e., it is required to guarantee that the interrupt-disabled status is set). After the execution of the two processes is guaranteed, the operation-mode management circuit 102 can perform a process of setting the operation mode to the HV mode. In other words, the above three processes are required to be performed in an inseparable manner. The meaning of inseparably performing processes is that there must be no other process between the processes. In addition, naturally it is required to protect the HV code from being altered by other softwares including the guest OS.

When the entry field of the HV code according to the first embodiment is properly executed, it is possible to confirm whether the processor 101 is in the interrupt-disabled status. Therefore, it becomes a critical point whether the entry field is properly executed without being interrupted by an illegal user code. From this point of view, the operation-mode management circuit 102 according to the first embodiment guarantees that the entry field of equal to or more than two instructions is inseparably executed, by measuring an execution time of the entry field.

It is determined whether to switch the operation mode to the HV mode, based on whether the entry field of equal to or more than two instructions is inseparably executed. With this scheme, when the operation-mode management circuit 102 switches the operation mode to the HV mode, it is guaranteed that only the HV code is executed in the interrupt-disabled status.

To prevent a deception of the interrupt, the operation-mode management circuit 102 guarantees that the entry field of equal to or more than two instructions is inseparably executed by measuring the execution time of the entry field. Details on the processing procedure will be described later.

The process of shifting an execution to the HV code and the process of setting the interrupt-disabled status are performed by a software working on the processor 101. The operation-mode management circuit 102 performs a detection of the execution request and the execution result of the processes. As a method for the detection, the operation-mode management circuit 102 monitors a type of an access request, an address, and data transmitted and received via the first channel that connects the processor 101 and the protection memory 107. A configuration of the operation-mode management circuit 102 is explained below.

The fetch detecting unit 121 performs a detection of a instruction fetch via the first channel that connects the processor 101 and the second HV-area protection circuit 106. After finishing an initialization at the time of starting the system LSI 100 or when a software such as the guest OS is being executed on the processor 101, the fetch detecting unit 121 detects a instruction fetch of the entry field of the HV code stored in the HV-code storage area 112.

The fetch determining unit 122 determines whether the instruction fetch detected by the fetch detecting unit 121 is an address of the first instruction executed at first of the entry field of the HV code stored in the HV-code storage area 112 of the protection memory 107 (for example, the instruction 1 shown in FIG. 2). Details on the determination procedure will be described later.

Furthermore, the fetch determining unit 122 determines whether the instruction fetch detected by the fetch detecting unit 121 is an address of an exit instruction included in an exit field of the HV code stored in the HV-code storage area 112 of the protection memory 107 (for example, an address of the “return” 203 shown in FIG. 2).

When the fetch determining unit 122 determined that a fetch has been performed for the first instruction of the entry field of the HV code (for example, the instruction 1 shown in FIG. 2), the time measuring unit 123 starts measuring time. It is assumed that the time measured by the time measuring unit 123 is the time obtained by counting some sort of clock signals used in the system LSI 100. Because the purpose of measuring the time is to measure a instruction execution time in the processor 101, the clock signal for the time measurement is desired to be a clock signal that becomes a reference for operation progress of the processor 101.

The instruction detecting unit 124 detects an execution of the last instruction of the entry field of the HV code (for example, the instruction 2 shown in FIG. 2) by the processor 101. According to the first embodiment, the instruction detecting unit 124 performs a detection of a data writing request from the processor 101. Although the instruction detecting unit 124 performs a detection of the instruction 2 in the example shown in FIG. 2 where the number of instructions in the entry field is two, if the entry field is configured with n pieces of instructions, the instruction detecting unit 124 performs a detection of the last (n-th) instruction. In addition, although it is different from the first embodiment, the instruction of which the execution is detected by the instruction detecting unit 124 is not limited to the last instruction, but any instruction will do as long as the instruction is a specific instruction with which it can be confirmed that the interrupt is disabled.

The time determining unit 125 determines whether a predetermined time has passed since the time measuring unit 123 started measuring the time. The predetermined time is set based on the time required to execute all of the instructions in the entry field. With this scheme, if the instruction detecting unit 124 cannot detect the instruction when the time determining unit 125 determined that the predetermined time has passed, it can be determined that there is an interrupt by another software.

The execution determining unit 126 determines whether the processor 101 is in the interrupt disabled status from a result of executing the instruction detected by the instruction detecting unit 124. According to the first embodiment, the execution determining unit 126 determines whether a value specified by a writing request with respect to the address CheckAdr from the processor 101 is a value indicating the interrupt disabled status. With this scheme, it is possible to determine whether the processor 101 is in the interrupt disabled status.

The mode switching unit 127 performs a switching of the operation mode based on a result of determination by the execution determining unit 126. For example, when the execution determining unit 126 determined that the processor 101 is in the interrupt disabled status, the mode switching unit 127 switches the operation mode to the HV mode, considering that the hypervisor is working on the processor 101 in the interrupt disabled status.

In an HV protection area, which will be described later, the first HV-area protection circuit 104 and the second HV-area protection circuit 106 perform a process of changing an access range in the memory 150, an address on the protection memory 107, or the device 160, based on the operation mode.

With this scheme, only when the HV code is executed in the interrupt disabled status, an access is released to all of the access destinations included in the HV protection area. On the other hand, in the case of the normal mode, an access is released to the first guest OS and the like for an access range that is narrower than all of the access destinations (range) included in the HV protection area.

When the fetch determining unit 122 determined that the instruction fetch is the address of the exit instruction, the mode switching unit 127 switches the operation mode to the normal mode, considering that the software such as the first guest OS is working on the processor 101. Details on a switching condition and the like will be described later.

According to the first embodiment, an area where a change of a range for which an access is allowed according to a software working on the processor 101 is defined as the HV protection area in the system LSI 100. As shown in FIG. 1, the HV protection area includes the memory-access control unit 103, the device-access control unit 105, the protection memory 107, the first HV-area protection circuit 104, and the second HV-area protection circuit 106.

A predetermined limitation is set in the structural elements (a memory or a circuit) stored in the HV protection area with respect to an access (reading/writing) from the processor 101. With this scheme, control information for the memory or the device, management information for the Guest OS, and the like can be accessed or written only by the HV code; and therefore, it is possible to prevent an illegal process by the guest OS and the like.

Although the structural elements are stored in the HV protection area (the memory or the circuit) according to the first embodiment, there is no limitation in such structure. As a modification of the first embodiment, the HV protection area of the system LSI can include only the HV-area protection circuit and the memory-access control unit, only the HV-area protection circuit and the protection memory, or a combination of more than two elements including the HV-area protection circuit and the protection memory. Details on other combinations will be described later.

The protection memory 107 stores therein the HV-code storage area 112. Furthermore, the protection memory 107 is write-protected in the normal mode.

According to the first embodiment, the HV-code storage area 112 is provided in the protection memory 107 that is disposed in the HV protection area. The HV-code storage area 112 is write-protected when the operation mode is other than the HV mode by the second HV-area protection circuit 106. With this scheme, it is possible to prevent an alteration of the HV code by the guest OS. Although the HV-code storage area 112 is provided in the HV protection area according to the first embodiment, it does not mean that the location of the HV-code storage area 112 is limited within the HV protection area. The HV-code storage area 112 can be provided in any place as long as the place can prevent an alteration of the HV-code storage area 112 from the guest OS, for example, in the memory 150 (in this case, it is required to connect the operation-mode management circuit 102 to the channel 6).

Although the HV-code storage area 112 is protected by the second HV-area protection circuit 106 according to the first embodiment, the HV-code storage area 112 can be provided on a read only memory (ROM) with which writing is impossible from the system LSI 100 as another embodiment.

In addition, the second HV-area protection circuit 106 can perform a control not only to inhibit writing to the HV-code storage area 112 but also to inhibit all operations for an address of a main body of the HV code excluding the entry field of the HV code. With such control by the second HV-area protection circuit 106, it is also possible to prevent reading of the main body of the HV code in the normal mode. With this scheme, it is possible to hide a process content of the HV code from the guest OS, which can also enhance the safety.

Details on the hypervisor stored in the HV-code storage area 112, the first guest OS stored in the first guest-OS storage area 151, the second guest OS stored in the second guest-OS storage area 152, and the third guest OS stored in the third guest-OS storage area 153 are explained below.

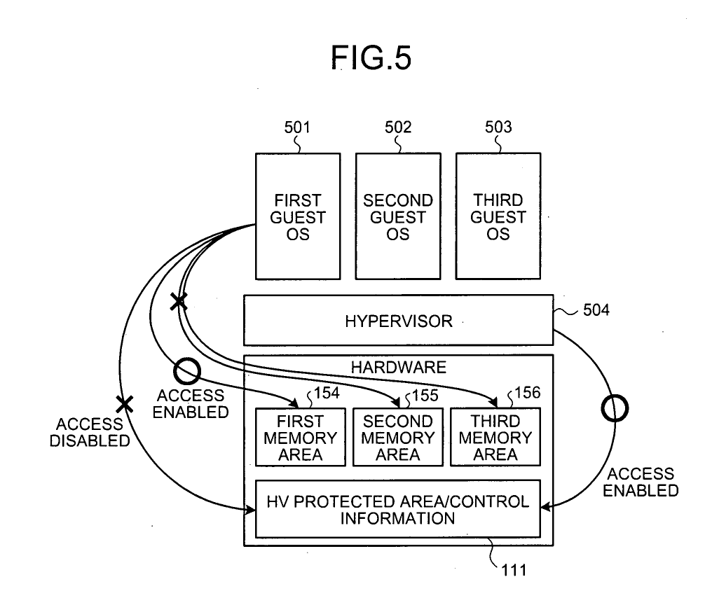

As shown in FIG. 5, a hypervisor 504 is arranged as the bottom layer of the software on the hardware in the system LSI 100 according to the first embodiment. A first guest OS 501, a second guest OS 502, and a third guest OS 503 are arranged on the hypervisor 504. To make the explanation easy, the first memory area 154, the second memory area 155, and the third memory area 156 in the memory 150 and control information stored in the memory-access control unit 103 and the device-access control unit 105 of an HV protection area 111 are shown in FIG. 5 as a configuration of the hardware. However, the same control is supposed to be performed for other schemes of configuration.

The hypervisor provides a function of switching the guest OS. In the system LSI 100, when switching the guest OS, the process control is returned to the hypervisor from an arbitrary guest OS, and then saving of a status of the current guest OS and returning to a status of the next guest OS are performed.

When the process control is shifted from the guest OS to the hypervisor, the operation mode is switched to the HV mode. At this moment, the hypervisor can update control information that is referred to when the memory-access control unit 103 and the device-access control unit 105 perform a control. The hypervisor updates the control information in such a manner that an access is allowed only for the memory and the device that are allocated to the next guest OS. In this manner, the hypervisor working in the HV mode can access all the hardwares (access destinations) included in the HV protection area.

Then, at the stage where the process control is shifted to the next guest OS from the hypervisor, the operation mode is switched to the normal mode. In the normal mode, an update of the control information cannot be performed. Then, the memory-access control unit 103 can release only an access to the first memory area 154 to the first guest OS 501 and prevent an access to the second memory area 155 and the third memory area 156. With this scheme, in the system LSI 100 according to the first embodiment, it is possible to prevent an illegal guest OS from accessing the memory and the device that are allocated to other guest OS. In the software configuration of the system LSI 100 according to the first embodiment, a plurality of guest OS's is working in a separated manner as described above.

Referring back to FIG. 1, the second HV-area protection circuit 106 is arranged between the processor 101 and the protection memory 107, and performs a process for protecting the protection memory 107. According to the first embodiment, the processor 101 and the second HV-area protection circuit 106 are connected with the first channel, and the second HV-area protection circuit 106 and the protection memory 107 are connected with the third channel. A mode information signal indicating the operation mode is input to the second HV-area protection circuit 106 from the operation-mode management circuit 102.

The second HV-area protection circuit 106 includes a second control unit 132, and receives an access request from the processor 101 via the first channel. When the mode information signal input from the operation-mode management circuit 102 is a value indicating the HV mode, the second HV-area protection circuit 106 outputs the received access request to the protection memory 107 via the third channel.

When the input mode information signal indicates that the operation mode is the HV mode, the second control unit 132 performs a control to allow the access request to the protection memory 107. On the other hand, when the input mode information signal indicates that the operation mode is the normal mode, the second control unit 132 performs a control to inhibit the access request to the protection memory 107.

With this scheme, the second HV-area protection circuit 106 is inhibited to output the received access request to the protection memory 107 when the input mode information signal is a value indicating a mode other than the HV mode. Example of a limitation to the access to the protection memory 107 include a case where the access is inhibited to a part of addresses of the protection memory 107, a case where only writing is inhibited, and the like. Furthermore, the above limitations can be combined as appropriate. Such limitations are effective when limiting an access to a part of the protection memory 107 in the normal mode or when inhibiting a part of operations (only for writing protecting and the like).

When performing a hide of the HV code, the second HV-area protection circuit 106 allows only the address corresponding to the entry field of the HV code in the HV-code storage area 112 to be always read out, and the address corresponding to the main body of the HV code to be read out only in the HV mode. A processing procedure for switching the operation mode to the HV mode at the time of executing the HV code will be described later. By performing the above processes, it is possible to enhance the safety.

Although an example is explained where the second HV-area protection circuit 106 and the protection memory 107 are separated according to the first embodiment, these functions can be arranged in the processor 101 as a single structural element.

The first HV-area protection circuit 104 includes a first control unit 131, and receives an access request from the processor 101 via the first channel. The first HV-area protection circuit 104 connects the memory-access control unit 103 and the device-access control unit 105 with the second channel. A mode information signal is input to the first HV-area protection circuit 104 from the operation-mode management circuit 102.

The memory-access control unit 103 is connected to the memory 150 via the fourth channel, and the device-access control unit 105 is connected to the device 160 via the fifth channel. The memory-access control unit 103 controls an access to the memory 150. In the system LSI 100 according to the first embodiment, the sixth channel is provided as a channel that connects the processor 101 and the memory-access control unit 103, and the first and the second channels are provided as a channel for accessing the control information of the memory-access control unit 103 from the processor 101. With this configuration, the access request to the memory 150 is output via the sixth channel. In addition, similar channels are also provided for the device-access control unit 105.

The memory-access control unit 103 receives an access (at least writing or both reading and writing) to a predetermined address of the control information from the processor 101 via the first channel and the first HV-area protection circuit 104. In the memory-access control unit 103 according to the first embodiment, the one that becomes a target to be protected is the control information.

The memory-access control unit 103 transmits the access request to the memory 150 received from the processor 101 via the sixth channel to the memory 150 via the fourth channel. At this time, the memory-access control unit 103 adds a limitation to the access request to be transmitted to the memory 150 according to preset control information.

The control information set in the memory-access control unit 103 can be realized in various schemes. For example, a plurality of pairs of <start address, end address> is set. If the address of the access request to the memory 150 is within the address range indicated by the address pairs, the access request is transmitted to the fourth channel. The address pairs can be edited only in the HV mode.

When the mode information signal indicating the HV mode is input to the first HV-area protection circuit 104, the memory-access control unit 103 accepts an access to the address allocated to writing/reading of the control information. On the other hand, when the mode information signal indicating a mode other than the HV mode is input to the first HV-area protection circuit 104, the memory-access control unit 103 does not accept an access to the address allocated to writing/reading of the control information.

According to the first embodiment, two paths are provided as a path connecting the processor 101 and the memory-access control unit 103, including the sixth channel and a path routing from the processor 101 to the first channel, the first HV-area protection circuit 104, and the second channel. However, the first embodiment is not limited to such a scheme that provides a plurality of paths. For example, only the path routing from the processor 101 to the first channel, the first HV-area protection circuit 104, and the second channel can be used.

In this manner, because writing/reading of the control information can be performed only in the HV mode, the hypervisor performs an appropriate setting for the next guest OS by changing the control information of the memory-access control unit 103; and therefore, the memory-access control unit 103 can allow only the data of the next guest OS to be accessed.

When the input mode information signal indicates that the operation mode is the HV mode, the first control unit 131 performs a control to release an access to the control information of the memory-access control unit 103 and the device-access control unit 105. On the other hand, when the input mode information signal indicates that the operation mode is the normal mode, the first control unit 131 performs a control to inhibit an access to the control information of the memory-access control unit 103 and the device-access control unit 105.

By taking the above configuration of the channels, the first HV-area protection circuit 104 does not need to perform a process for an access request other than writing/reading the control information of the memory-access control unit 103 and the device-access control unit 105.

Upon receiving an access request to the address allocated to writing/reading control information of the memory-access control unit 103 from the processor 101, if the mode information signal input from the operation-mode management circuit 102 is a value indicating the HV mode, the first HV-area protection circuit 104 outputs the access request to the memory-access control unit 103 via the second communication line. On the other hand, if the mode information signal input from the operation-mode management circuit 102 is a value indicating a mode other than the HV mode, the first HV-area protection circuit 104 inhibits an output of the access request to the memory-access control unit 103.

According to the first embodiment, data is transmitted and received via the first and the second channels for an access request to the control information of the memory-access control unit 103, and data is transmitted and received via the sixth channel for an access request to the memory-access control unit 103 other than the control information. However, although it is different from the first embodiment, these separated channels can be configured with a single communication routed through the first HV-area protection circuit 104. In this case, the access request to the memory 150 is also performed via the first HV-area protection circuit 104. Furthermore, although a control of writing/reading with respect to the control information of the memory-access control unit 103 is performed in the above manner, the first HV-area protection circuit 104 outputs all other access requests (for example, an access request to the memory 150) are output to the memory-access control unit 103.

The device-access control unit 105 controls an access to the device 160. Furthermore, the device-access control unit 105 receives an access request to the control information of the device-access control unit 105 via the first HV-area protection circuit 104 in a similar manner to the memory-access control unit 103. Because a process performed by the device-access control unit 105 is the same as the process performed by the memory-access control unit 103, a detailed explanation is omitted.

The control information set in the device-access control unit 105 can be realized in various schemes. For example, a plurality of pairs of <start address, end address> is set. If the address of the access request to the device 160 is within the address range indicated by the address pairs, the access request is transmitted to the fifth channel. The address pairs can be edited only in the HV mode.

As another scheme of the control information, when a plurality of devices is connected, the <start address, end address> pair corresponding to each of the devices can be set in advance, and whether to release the access to the address can be set as a bit mask 1 bit. In this scheme, if an address of an access request to a device is within the address range allocated to a device corresponding to the bit mask “1”, the access request will be output.

According to the first embodiment, the hypervisor performs rewriting of the control information of the device-access control unit 105 when, for example, switching the guest OS; and therefore, it is possible to release an access only to a device allocated to a working guest OS.

A process performed by the operation-mode management circuit 102 is explained below. The operation performed by the operation-mode management circuit 102 is roughly classified into two operations as follows.

As for the first operation, when the operation mode is the normal mode, the operation-mode management circuit 102 performs a check of an entry of the HV mode, and if a predetermined condition is satisfied, shifts the operation mode to the HV mode. As for the second operation, when the operation mode is the normal mode, the operation-mode management circuit 102 performs a check of an exit of the HV mode, and if a predetermined condition is satisfied, shifts the operation mode to the normal mode.

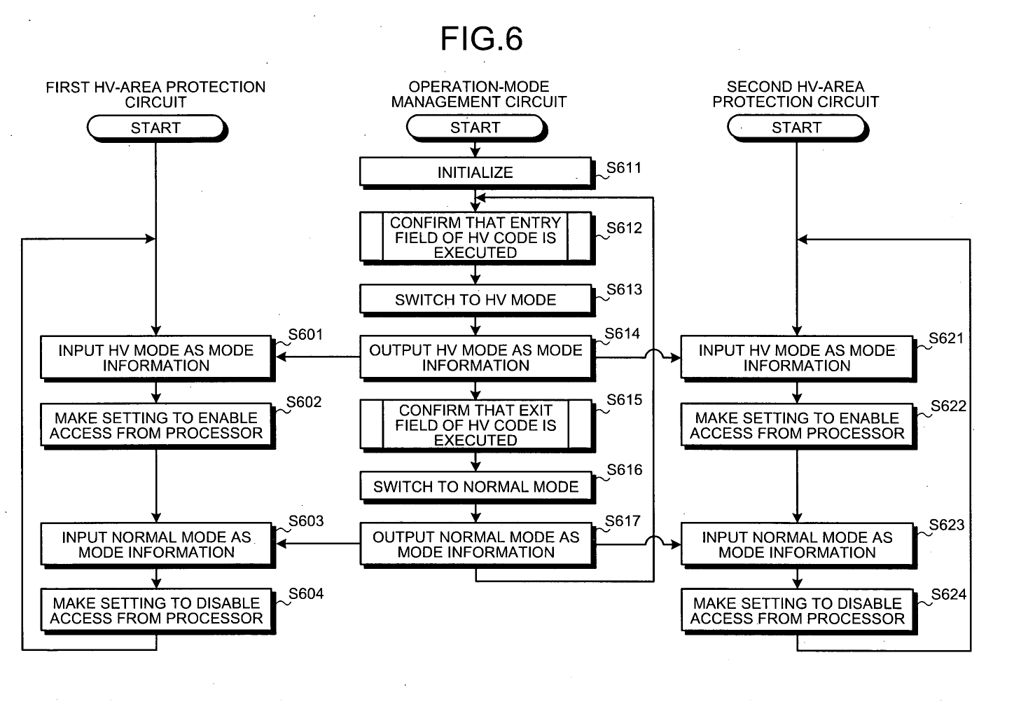

As shown in FIG. 6, the operation-mode management circuit 102 performs an initialization of the system LSI 100 at the time of system start-up (Step S611). At this time, the operation mode is set to the normal mode.

After performing the initialization of the system, the fetch detecting unit 121 and the like of the operation-mode management circuit 102 monitors the first channel, and confirms that the entry field of the HV code is appropriately executed (Step S612). The process of Step S612 is repeated at predetermined time intervals until it is determined that the entry field is executed appropriately. Details on the processing procedure will be described later.

Subsequently, the mode switching unit 127 performs a process of switching the operation mode to the HV mode (Step S613). Then, the operation-mode management circuit 102 outputs a mode information signal indicating that the operation mode is the HV mode to the first HV-area protection circuit 104 and the second HV-area protection circuit 106 (Step S614). Although it is explained that the mode information signal is output at this timing in the flowchart shown in FIG. 6 for the sake of an easy explanation, the operation-mode management circuit 102 constantly outputs the mode information signal at predetermined time intervals in practice. The operation-mode management circuit 102 can also constantly output the mode information signal to a signal line. In either case, the operation-mode management circuit 102 can transmit a timing for a mode switch to the first HV-area protection circuit 104 and the second HV-area protection circuit 106. Up to now is corresponding to the first operation.

The first HV-area protection circuit 104 receives an input of the mode information signal from the operation-mode management circuit 102, and recognizes that the operation mode is switched to the HV mode (Step S601). Then, the first control unit 131 performs a control to release an access to the control information of the memory-access control unit 103 and the device-access control unit 105 (Step S602).

In a similar manner, upon receiving an input of the mode information signal from the operation-mode management circuit 102, the second HV-area protection circuit 106 recognizes that the operation mode is switched to the HV mode (Step S621). Then, the second control unit 132 performs a control to release an access to the protection memory 107 (Step S622).

After that, the fetch detecting unit 121 of the operation-mode management circuit 102 monitors the first channel, and confirms that the exit entry of the HV code is appropriately executed (Step S615). The process of Step S615 is repeated at predetermined time intervals until it is determined that the exit field is executed appropriately. Details on the processing procedure will be described later.

Subsequently, the mode switching unit 127 performs a process of switching the operation mode to the normal mode (Step S616). On the processor 101, the operation mode is switched to the normal mode at Step S616 for other software, so that the other software such as the guest OS is executed.

The operation-mode management circuit 102 outputs a mode information signal indicating that the operation mode is the normal mode to the first HV-area protection circuit 104 and the second HV-area protection circuit 106 (Step S617). Up to now is corresponding to the second operation. After that, the fetch detecting unit 121 and the like of the operation-mode management circuit 102 monitors the first channel again, and confirms that the entry field of the HV code is appropriately executed (Step S612).

Upon receiving an input of the mode information signal from the operation-mode management circuit 102, the first HV-area protection circuit 104 recognizes that the operation mode is switched to the normal mode (Step S603). Then, the first control unit 131 immediately performs a control to inhibit an access to the control information of the memory-access control unit 103 and the device-access control unit 105 (Step S604).

In a similar manner, upon receiving an input of the mode information signal from the operation-mode management circuit 102, the second HV-area protection circuit 106 recognizes that the operation mode is switched to the normal mode (Step S623). Then, the second control unit 132 immediately performs a control to inhibit an access to the protection memory 107 (Step S624).

According to the first embodiment, the configuration stored in the HV protection area can be properly protected depending on the operation mode by repeating the above processes.

The processing procedure for confirming that the entry field of the HV code is appropriately executed, which is described at Step S612 shown in FIG. 6, is explained below. A method of checking the entry field of the HV code includes a plurality of schemes depending on a combination of the contents of the entry field of the HV code and the configuration of the system LSI. One of the schemes is explained in the first embodiment. The other schemes will be explained in other embodiments described later.

A method of confirming the appropriate execution of the entry field of the HV code according to the first embodiment is to determine whether the entry field is executed within a predetermined time. Furthermore, when the entry field of the HV code is executed, it is confirmed that the processor 101 is in an interrupt disabled status. Therefore, according to the first embodiment, when the entry field is executed within the predetermined time and when the interrupt disabled status is confirmed, the operation mode is switched to the HV mode.

When the entry field of the HV code is executed, a signal is transmitted from the processor 101 to the first channel in the following order.

A request for a instruction fetch is transmitted from the processor 101 with respect to the address of the instruction 1 of the address “HVEntry” in the HV-code storage area 112. Then, the instruction 1 is transmitted from the HV-code storage area 112. After that, a request for a instruction fetch is transmitted form the processor 101 with respect to the address of the instruction 2. Then, the instruction 2 is transmitted from the HV-code storage area 112. In the case where the entry field includes n pieces of instructions, the instruction fetch request and the transmission of the instruction will be repeated n times.

The operation-mode management circuit 102 according to the first embodiment, measures an execution time from detection of the instruction fetch for the address of the instruction 1 to the execution of the instruction 2, and confirms whether the execution time is equal to (or shorter than) a reference time that is to be taken for a continuous execution of the instructions without being interrupted by an illegal user code. If the execution time is equal to (or shorter than) the reference time, the operation-mode management circuit 102 guarantees that the entry field of the HV code has been executed in an inseparable manner. Furthermore, by confirming the execution contents of the instruction 2, the operation-mode management circuit 102 guarantees that the processor 101 is in the interrupt disabled status. With the guarantees of the above facts, a condition for the operation-mode management circuit 102 to shift the operation mode to the HV mode is considered to be satisfied.

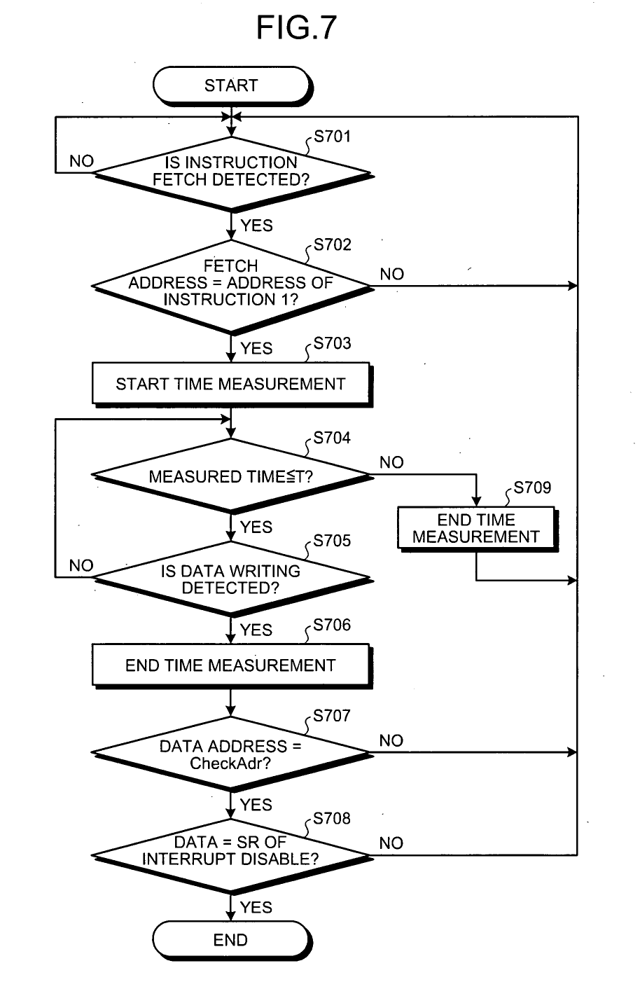

As shown in FIG. 7, the fetch detecting unit 121 monitors the first channel, and determines whether the instruction fetch request transmitted form the processor 101 is detected (Step S701). This process is repeated until the instruction fetch request is detected.

When the fetch detecting unit 121 detects the instruction fetch request (Yes at Step S701), the fetch determining unit 122 determines whether an address specified by the instruction fetch request is the address of the instruction 1 of the entry field (Step S702). When the fetch determining unit 122 determines that the address specified by the instruction fetch request is different from the address of the instruction 1 of the entry field (No at Step S702), a detection of the instruction fetch request by the fetch detecting unit 121 is performed again (Step S701).

On the other hand, when it is determined that the address specified by the instruction fetch request matches with the address of the instruction 1 (Yes at Step S702), the time measuring unit 123 starts measuring time (Step S703).

Subsequently, the time determining unit 125 determines whether a predetermined time T has passed since the time measuring unit 123 started measuring the time (Step S704). The predetermined time T is a preset time required from the detection of the fetch of the instruction 1 until the execution of the instruction 2.

When it is determined that the predetermined time T has passed (No at Step S704), the time measuring unit 123 stops measuring the time (Step S709), and the fetch detecting unit 121 detects the instruction fetch again (Step S701).

On the other hand, when it is determined that the predetermined time T has not passed (Yes at Step S704), the instruction detecting unit 124 monitors the first channel, and determines whether a data writing request from the processor 101 is detected (Step S705). When it is determined that the data writing request is not detected (No at Step S705), the process starts over from the determination whether the predetermined time T has passed by the time determining unit 125 (Step S704).

It is preferable that the predetermined time T should be an execution time required for a continuous execution of the entry field from the beginning. The execution time for the entry field is required to be adjusted in advance by calculating it from a simulation of an operation in the processor 101 or measuring an output signal from the processor 101 by actually executing the entry field on the processor. If there is a certain level of fluctuation in the execution time for the entry field, the maximum value of the execution time is taken as the predetermine time T.

When the instruction detecting unit 124 detects the data writing request (Yes at Step S705), the time measuring unit 123 stops measuring time (Step S706). Then, the instruction detecting unit 124 determines whether an address specified by the data writing request matches with the “CheckAdr” (Step S707). When it is determined that the address specified by the data writing request is different from the “CheckAdr” (No at Step S707), a detection of the instruction fetch request by the fetch detecting unit 121 is performed again (Step S701).

On the other hand, when it is determined that the address specified by the data writing request matches with the “CheckAdr” (Yes at Step S707), the execution determining unit 126 determines whether data specified by the writing request matches with a value of the “SR” that indicates the interrupt disabled status (Step S708). When it is determined that the data specified by the writing request is different from the value of the “SR” (No at Step S708), a detection of the instruction fetch request by the fetch detecting unit 121 is performed again (Step S701).

On the other hand, when it is determined that the data specified by the writing request matches with the value of the “SR” (Yes at Step S708), it is considered that a proper execution of the entry field of the HV code is confirmed. Then, the processes after Step S613 shown in FIG. 6 will be performed.

If the “SR” indicates only the interrupt disable/enable, the entire write data can be simply compared. However, the register indicating a status of the processor generally indicates various types of statuses, such as an interrupt status, an address translation mode, and a privilege mode, in units of bit. In this case, only the bit corresponding to the interrupt status can be compared.

The processing procedure for detecting the exit of the HV mode shown in Step S615 of FIG. 6 is explained below. The operation mode is switched to the HV mode by detecting a completion of a process by the hypervisor. The following example is, as a first scheme for checking an exit of the HV mode, an example in which the operation mode is switched to the normal mode when an execution of a instruction is assured with which a completion of a process that should operate in the HV mode is guaranteed (hereinafter, “a HV-mode exit instruction”).

The instruction with which a completion of the process that should operate in the HV mode is guaranteed depends on the HV code. Therefore, there are various schemes for the instruction depending on the HV code. For example, in the HV code shown in FIG. 2, a process by the HV code is complete when the last instruction of the HV code “return” 203 is called. Namely, when the processor 101 calls the last instruction 203 and switches the software to be executed to the guest OS, it is not necessary to operate the processes thereafter in the HV mode. In that sense, in the HV code shown in FIG. 2, the last instruction 203 is used as the HV-mode exit instruction. However, the first embodiment does not limit the HV-mode exit instruction to the last instruction of the HV code. A instruction preceding the last instruction of the HV code can be the HV-mode exit instruction as long as the instruction guarantees a completion of the process that should operate in the HV mode.

When the HV-mode exit instruction (the last instruction 203) shown in FIG. 2 is executed, the processor 101 transmits a request for a instruction fetch with respect to an address in which the HV-mode exit instruction is stored in the protection memory 107 (hereinafter, “HVExit”). Then, the data stored in the HV-code storage area 112 (a instruction stored in the “HVExit”) is transmitted from the protection memory 107 to the processor 101.

According to the first embodiment, when a instruction fetch for the address in which the HV-mode exit instruction is detected, the operation-mode management circuit 102 determines that the completion of the process that should operate in the HV mode is guaranteed, and switches the operation mode to the normal mode.

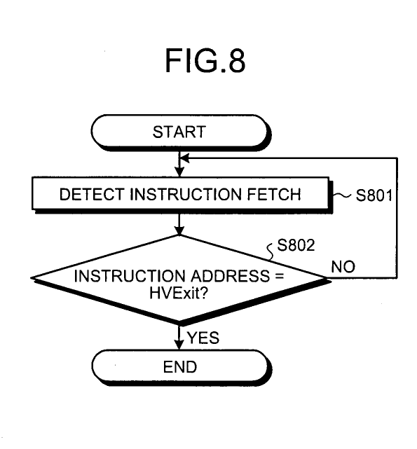

As shown in FIG. 8, the fetch detecting unit 121 monitors the first channel, and detects a request for a instruction fetch transmitted from the processor 101 (Step S801).

When the fetch detecting unit 121 detected the request for the instruction fetch, the fetch determining unit 122 determines whether an address specified by the request for the instruction fetch matches with the address of the exit instruction (the reference numeral 203 shown in FIG. 2) (Step S802). When it is determined that the address specified by the request for the instruction fetch is different from the address of the exit instruction (No at Step S802), the fetch detecting unit 121 performs a detection of the instruction fetch again (Step S801).

On the other hand, when it is determined that the address specified by the request for the instruction fetch matches with the address of the exit instruction (Yes at Step S802), the fetch detecting unit 121 determines that the HV-mode exit check is complete. Then, processes after Step S616 shown in FIG. 6 will be performed.

According to the first embodiment, the HV-code storage area 112 of the system LSI 100 is provided in the protection memory 107, and each of the guest-OS storage areas is provided in the memory 150. However, the HV-code storage area and each of the guest-OS storage areas can be provided in the same memory. In this case, an access to the HV-code storage area is limited by the memory-access control unit and the like.

As a method of limiting the HV protection area, a method other than the first embodiment can be used. For example, when the operation mode is a mode other than the HV mode, all operations (reading/writing) can be inhibited with respect to all memories stored in the HV protection area and all addresses of the devices. As another example, an access or writing can be inhibited only with respect to a part of the addresses stored in the HV protection area. In addition, a combination of the above limitations can also be used.

When there is no signal that distinguishes a instruction fetch from data reading in the data flowing on the channel, it is necessary to input a signal indicating a instruction fetch output from the processor 101 to the operation-mode management circuit via another path different from the channel. With this scheme, it is possible to distinguish the instruction fetch from the data reading.

Employing the system LSI 100 according to the first embodiment, it is possible to assure a protection area that can be only accessed at the time of executing the HV code, without depending on the virtualization support function of the processor. By storing access control information for a memory or a device, management information for the guest OS, and a main body of the HV code in the protection area, it is possible to prevent reading/writing of the above pieces of information by the guest OS. In this manner, by realizing a separation of the guest OS's for sure, it is possible to enhance the safety.

Although the entry field of the HV code is configured with a plurality of instructions in the system LSI 100 according to the first embodiment, because it is guaranteed that the instructions of the entry field is executed in an inseparable manner by measuring the time when the entry field is executed, it is possible to prevent another code from interrupting while the entry field is executed. With this scheme, it is possible to enhance the safety.

In the system LSI 100 according to the first embodiment, an example is explained in which the entry field of the HV code stored in the HV-code storage area 112 is configured with a plurality of instructions for confirming that the processor is in the interrupt disabled status. However, the entry field of the HV code is not limited to the above configuration. According to a second embodiment, an example will be explained in which the HV code stored in the HV-code storage area is configured with a plurality of instructions for disabling an interrupt.

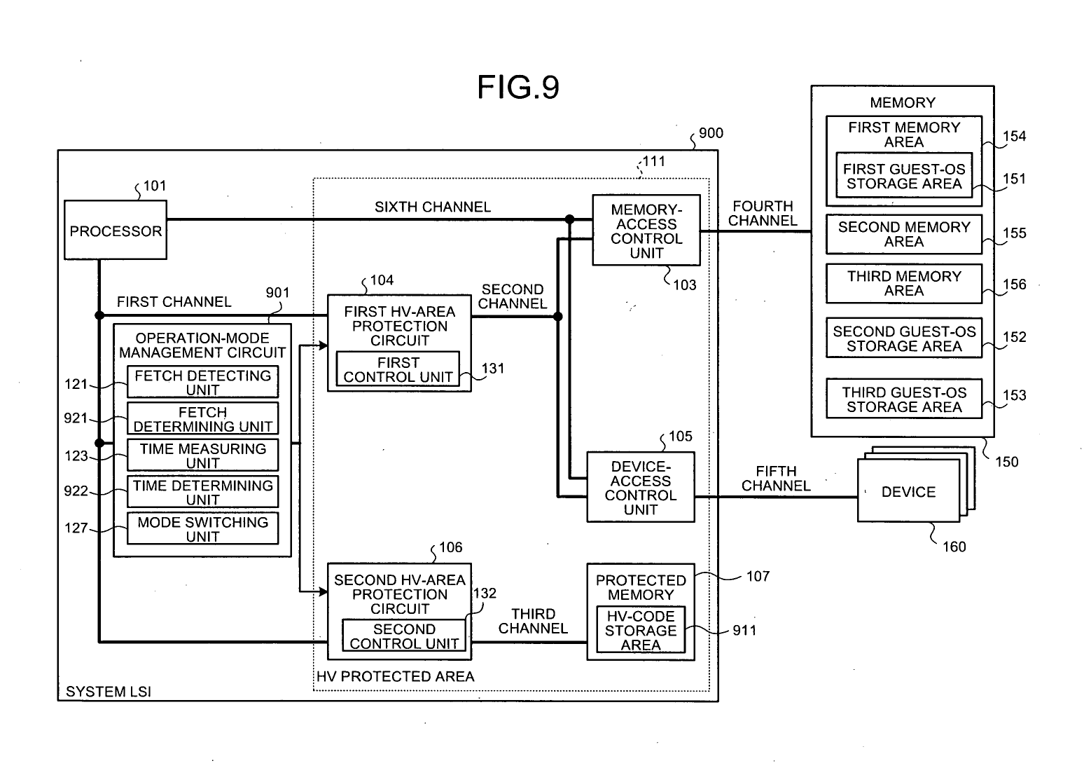

FIG. 9 is a block diagram illustrating a configuration of a system LSI 900 according to the second embodiment. A difference between the system LSI 100 according to the first embodiment and the system LSI 900 according to the second embodiment is that the system LSI 900 includes an operation-mode management circuit 901 of which a process is different from that of the operation-mode management circuit 102 and the protection memory 107 includes an HV-code storage area 911 having a binary code different from that stored in the HV-code storage area 112. An explanation about a common configuration with the system LSI 100 according to the first embodiment from among the configuration of the system LSI 900 according to the second embodiment will be omitted.

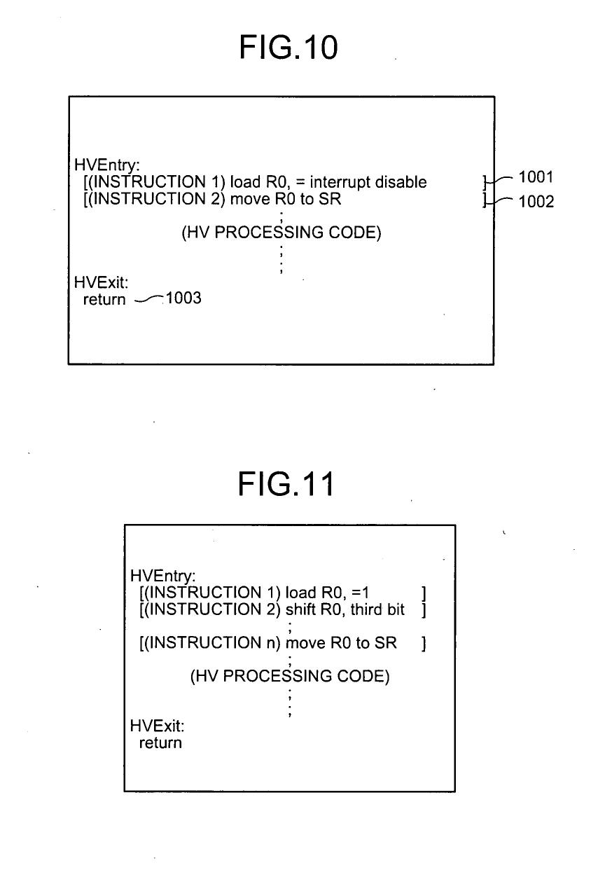

The HV-code storage area 911 stores therein the HV code. As shown in FIG. 10, the HV code includes the instruction 1 “load R0, =interrupt disable” 1001 and the instruction 2 “move R0 to SR” 1002 in the entry field and “return” 1003 as an exit code in the same manner as FIG. 2. In the entry field, a value indicating an interrupt disable is set to the “SR” that stores the status of the processor 101. Namely, unlike the system LSI 100 according to the first embodiment, it is not necessary to check the data written to the address “CheckAdr”. In other words, the system LSI 900 according to the second embodiment is an embodiment that can guarantee the interrupt disable simply by confirming a instruction fetch.

Although it is different from the second embodiment, the entry field of the HV code can be configured with more than two instructions. As shown in FIG. 11, a case can be considered where the entry field of the HV code is configured with n pieces of instructions. In the example shown in FIG. 11, a case where the third bit of the status register “SR” is “1” indicates the interrupt disable. Therefore, the third bit of the “SR” is set to “1” by executing n pieces of instructions. Even when the entry field is configured with n pieces of instructions as described above, it is much more likely that the process is interrupted by other codes in the middle of the process.

The reason why, the entry field is configured with a plurality of instructions in the second embodiment is because of a limitation of the instruction set of the processor 101 in the same manner as the first embodiment.

The operation-mode management circuit 901 is different from the operation-mode management circuit 102 according to the first embodiment in including a fetch determining unit 921 of which a process is different from that of the fetch determining unit 122 and a time determining unit 922 of which a process is different from that of the time determining unit 125 and in removing the execution determining unit 126.

The fetch determining unit 921 determines whether the instruction fetch detected by the fetch detecting unit 121 is an address of the last instruction of the entry field of the HV code stored in the HV-code storage area 911 of the protection memory 107 (for example, the instruction 2 shown in FIG. 10). Details on a method of determination will be described later.

The time determining unit 922 determines whether a predetermined time has passed since the time measuring unit 123 started measuring time. The predetermined time is set based on the time required to fetch all of the instructions in the entry field. With this scheme, if the fetch determining unit 921 cannot determine that the last instruction has been detected when the time determining unit 922 determined that the predetermined time has passed, it can be determined that there is an interrupt by another software.

A different point between a process of the system LSI 900 and a process of the system LSI 100 is a processing procedure in which the fetch detecting unit 121 and the like of the operation-mode management circuit 901 monitor the first channel and confirm an appropriate execution of the entry field of the HV code. The processing procedure for confirming an appropriate execution of the entry field is explained below.

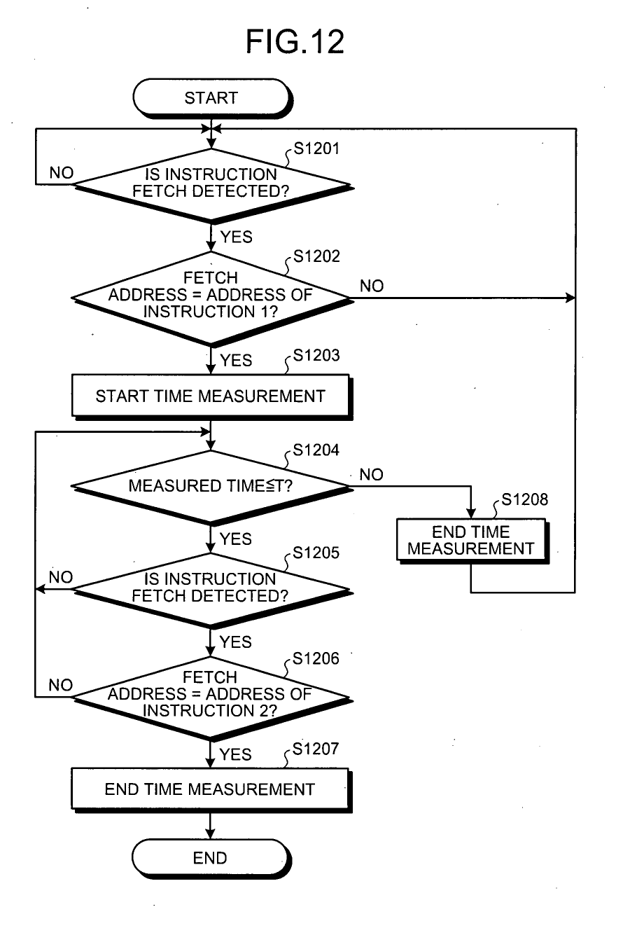

As shown in FIG. 12, the fetch detecting unit 121 monitors the first channel, and determines whether a instruction fetch request transmitted form the processor 101 is detected (Step S1201). This process is repeated until the instruction fetch request is detected.

When the fetch detecting unit 121 detects the instruction fetch request (Yes at Step S1201), the fetch determining unit 921 determines whether an address specified by the instruction fetch request is the address of the instruction 1 of the entry field (Step S1202). When the fetch determining unit 921 determines that the address specified by the instruction fetch request is different from the address of the instruction 1 of the entry field (No at Step S1202), a detection of the instruction fetch request by the fetch detecting unit 121 is performed again (Step S1201).

When it is determined that the address specified by the instruction fetch request matches with the address of the instruction 1 (Yes at Step S1202), the time measuring unit 123 starts measuring time (Step S1203).

Subsequently, the time determining unit 922 determines whether a predetermined time T has passed since the time measuring unit 123 started measuring the time (Step S1204). The predetermined time T is a preset time required from the detection of the fetch of the instruction 1 until the fetch of the instruction 2.

When it is determined that the predetermined time. T has passed (No at Step S1204), the time measuring unit 123 stops measuring the time (Step S1208), and the fetch detecting unit 121 detects the instruction fetch again (Step S1201).

On the other hand, when it is determined that the predetermined time T has not passed (Yes at Step S1204), the fetch detecting unit 121 monitors the first channel, and determines whether a instruction fetch request from the processor 101 is detected (Step S1205).

When the fetch detecting unit 121 fails to detect the instruction fetch (No at Step S1205), the process starts over from the determination whether the predetermined time T has passed by the time determining unit 922 (Step S1204).

On the other hand, when the fetch detecting unit 121 detects the instruction fetch (Yes at Step S1205), the fetch determining unit 921 determines whether an address specified by the instruction fetch request is the address of the instruction 2 of the entry field (Step S1206). When it is determined that the address specified by the instruction fetch request is not the address of the instruction 2 of the entry field (No at Step S1206), the process starts over from the determination whether the predetermined time T has passed by the time determining unit 922 (Step S1204).

On the other hand, when the fetch determining unit 921 determines that the address specified by the instruction fetch request is the address of the instruction 2 (Yes at Step S1206), the time measuring unit 123 stops measuring the time (Step S1207). Then, the processes after Step S613 shown in FIG. 6 will be executed.

According to the second embodiment, once the address of the instruction 2 is checked, the write-protected status is set by the instruction 2. With this scheme, it is guaranteed that the processor 101 is in the write-protected status. In other words, because the inseparable execution of a plurality of instructions of the entry field is guaranteed without confirming a result of execution of the instructions unlike the first embodiment, it is possible to secure the safety.

In the system LSIs according to the first and the second embodiments, an example is explained in which an interrupt by another program is prevented by measuring the time for executing all the instructions. However, the interrupt preventing method is not limited to the time measurement. According to a third embodiment, the interrupt by the other program is prevented by detecting an execution of the instruction fetch in the entry field of the HV code in the order of the instructions.

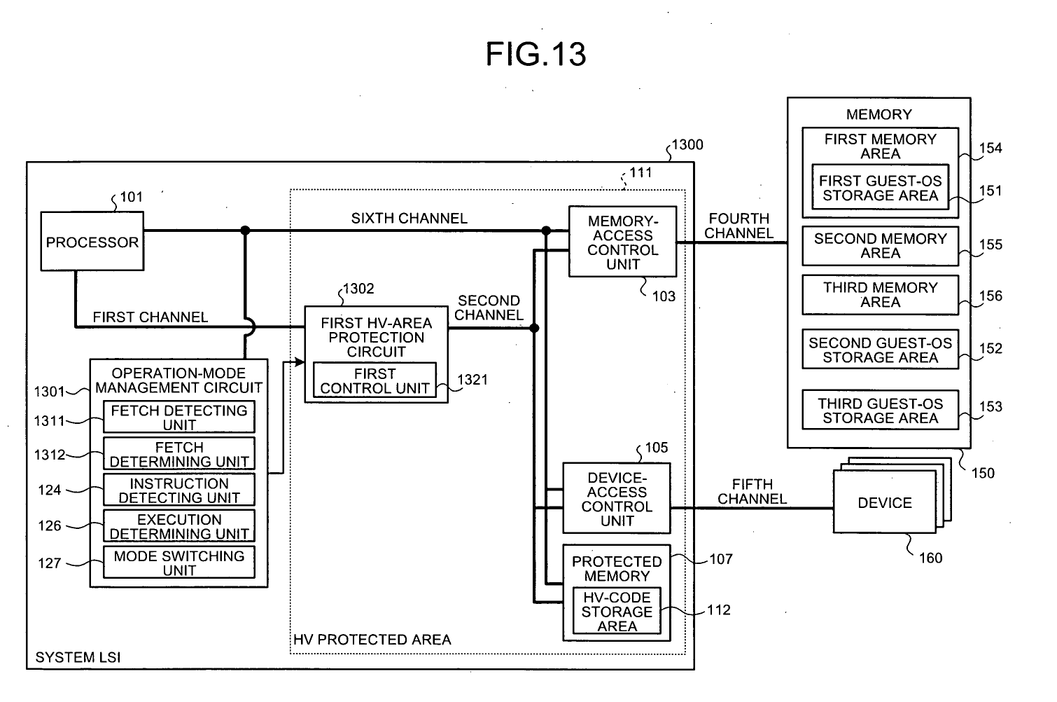

FIG. 13 is a block diagram illustrating a configuration of a system LSI 1300 according to the third embodiment. A difference between the system LSI 100 according to the first embodiment and the system LSI 1300 according to the third embodiment is that the system LSI 1300 includes an operation-mode management circuit 1301 of which a process is different from that of the operation-mode management circuit 102 and a first HV-area protection circuit 1302 of which a process is different from that of the first HV-area protection circuit104, the second HV-area protection circuit 106 is removed, and the connection destinations of the first, the second, and the sixth channels are changed. An explanation about a common configuration with the system LSI 100 according to the first embodiment from among the configuration of the system LSI 1300 according to the second embodiment will be omitted.

Furthermore, the HV code according to the third embodiment is the same as the HV code described in the first embodiment; and therefore, details on the HV code will not be explained. When the entry filed of such an HV code is configured with more than two instructions, there is a possibility that an arbitrary user code is executed while processing the HV code so that the interrupt disabled status is disguised.

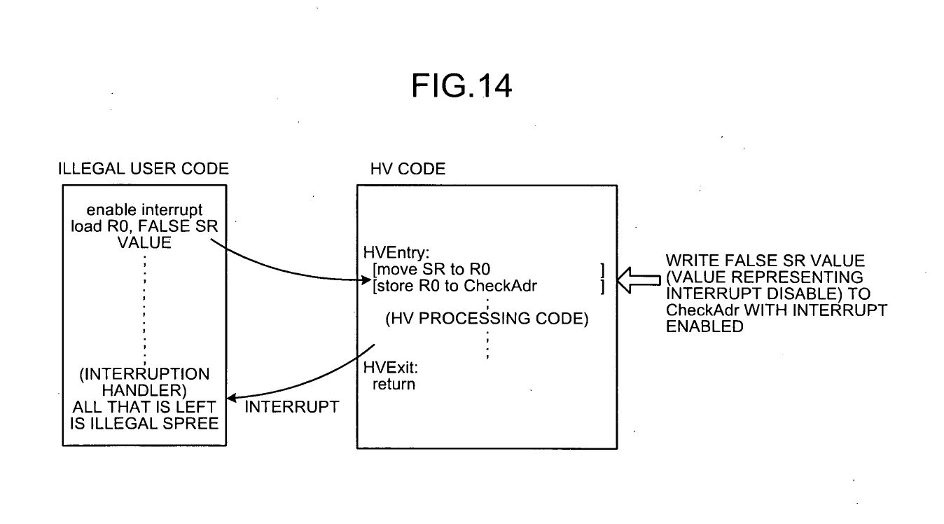

FIG. 14 is a schematic diagram illustrating a process in which the interrupt disabled status is disguised in the HV code shown in FIG. 2. In the example shown in FIG. 14, an illegal user code intrudes in the middle of the entry field of the HV code and disguises the status of the processor 101 as the interrupt disabled status. The illegal user code allows an interrupt to the processor 101 by executing a instruction “enable interrupt”. After that, the illegal user code causes a value of a false “SR” to be loaded to the general-purpose register “R0” by executing a instruction “load R0, false SR value”. Then, the illegal user code jumps the instruction 2 of the entry field. Consequently, when executing the instruction 2, the processor 101 writes the false SR value representing the interrupt disabled status in the “CheckAdr” in spite that the interrupt is allowed in practice. This leads the operation-mode management circuit to determine that the processor is in the interrupt disabled status by referring to the value of the “CheckAdr”, so that the hypervisor is executed in an interrupt enabled status, and the operation mode is switched to the HV mode. If an interrupt is made by an illegal user code at this time, the process control jumps to the interrupt handler of the illegal user code in the HV mode.

Furthermore, in the example shown in FIG. 14, because all of the entry field of the HV code is not necessarily executed, the execution time of the entry field may be short even if it is interrupted by the illegal user code. For this reason, the method described in the first embodiment can be hardly employed.

In the operation-mode management circuit 1301 according to the third embodiment, the interrupt disabled status is guaranteed by confirming that the instructions of the entry field are fetched in the order of the instructions. Because the operation-mode management circuit 1301 according to the third embodiment monitors the first channel, it can monitor not only a fetch request from the processor 101 to the protection memory 107 but also a fetch request to the memory 150. If the fetch requests executed in the order of the instructions with respect to the entry field, it means that the fetch request is not performed for a code other than the HV code. Therefore, the operation-mode management circuit 1301 can guarantee that there is no interrupt by another code.

Referring back to FIG. 13, a difference between the operation-mode management circuit 1301 and the operation-mode management circuit 102 according to the first embodiment is that the operation-mode management circuit 1301 includes a fetch detecting unit 1311 of which a process is different from that of the fetch detecting unit 121 and a fetch determining unit 1312 of which a process is different from that of the fetch determining unit 122, and the time measuring unit 123 and the time determining unit 125 are removed.

The fetch detecting unit 1311 performs a detection of the instruction fetch via the sixth channel that connects the processor 101, the memory-access control unit 103, the device-access control unit 105, and the protection memory 107.

The fetch determining unit 1312 determines whether the instruction fetch detected by the fetch detecting unit 1311 is an address of each of the instructions constituting the entry field of the HV code stored in the HV-code storage area 112 of the protection memory 107. Furthermore, the fetch determining unit 1312 also determines whether the instruction fetches are performed in the order of the instructions of the entry field.

The first HV-area protection circuit 1302 includes a first control unit 1321, and receives an access request from the processor 101 via the first channel. The first HV-area protection circuit 1302 connects the memory-access control unit 103, the device-access control unit 105, and the protection memory 107 with the second channel. A mode information signal is input to the first HV-area protection circuit 1302 from the operation-mode management circuit 1301.

When the input mode information signal indicates that the operation mode is the HV mode, the first control unit 1321 performs a control to release an access to the control information of the memory-access control unit 103 and the device-access control unit 105 and an access to the protection memory 107. On the other hand, when the input mode information signal indicates that the operation mode is the normal mode, the first control unit 1321 performs a control to inhibit an access to the control information of the memory-access control unit 103 and the device-access control unit 105 and an access to the protection memory 107.

A different point between a process of the system LSI 1300 and a process of the system LSI 100 is a processing procedure in which the fetch detecting unit 1311 and the like of the operation-mode management circuit 1301 monitor the first channel and confirm an appropriate execution of the entry field of the HV code. The processing procedure for confirming an appropriate execution of the entry field is explained below.

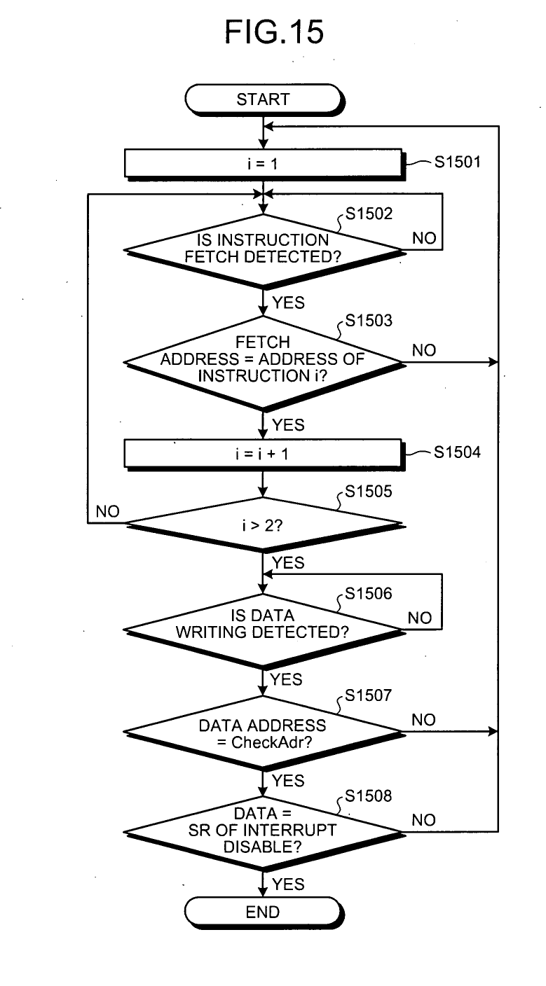

As shown in FIG. 15, the operation-mode management circuit 1301 sets “1” to a variable i as an initial value for an entry check (Step S1501). After that, the fetch detecting unit 1311 monitors the sixth channel, and determines whether a instruction fetch request transmitted from the processor 101 is detected (Step S1502). This process is repeated until the instruction fetch request is detected.

When the fetch detecting unit 1311 detects the instruction fetch request (Yes at Step S1502), the fetch determining unit 1312 determines whether an address specified by the instruction fetch request is an address of i-th instruction (at first i=“1”) of the entry field (Step S1503). When the fetch determining unit 1312 determines that the address specified by the instruction fetch request is different from the address of the i-th instruction of the entry field (No at Step S1503), the operation-mode management circuit 1301 starts over from the process of setting “1” to the variable i as the initial value (Step S1501).

On the other hand, when it is determined that the address specified by the instruction fetch request matches with the address of the i-th instruction (Yes at Step S1503), the operation-mode management circuit 1301 adds “1” to the variable i (Step S1504). Then, the operation-mode management circuit 1301 determines whether the variable i is larger than “2” (Step S1505). Namely, the above processes are repeated by the number of instructions included in the entry field of the HV code.

At Step S1505, it is determined whether the variable i is larger than “2” because the entry field of the HV code according to the third embodiment is configured with two instructions. It means that, if the entry field is configured with n pieces of instructions, it will be determined whether the variable i is larger than “n”.

When the operation-mode management circuit 1301 determines that the variable i is not larger than “2” (No at Step S1505), the fetch detecting unit 1311 performs again a determination whether the instruction fetch request transmitted from the processor 101 is detected (Step S1502).

On the other hand, when the operation-mode management circuit 1301 determines that the variable i is larger than “2” (Yes at Step S1505), the instruction detecting unit 124 monitors the sixth channel, and determines whether a data writing request from the processor 101 is detected (Step S1506). When it is determined that the data writing request is not detected (No at Step S1506), the process is repeated until the data writing request is detected.

On the other hand, when the instruction detecting unit 124 detects the data writing request (Yes at Step S1506), the instruction detecting unit 124 determines whether an address specified by the data writing request matches with the “CheckAdr” (Step S1507). When it is determined that the address specified by the data writing request is different from the “CheckAdr” (No at Step S1507), the operation-mode management circuit 1301 starts over from the process of setting “1” to the variable i as the initial value (Step S1501).

On the other hand, when it is determined that the address specified by the data writing request matches with the “CheckAdr” (Yes at Step S1507), the execution determining unit 126 determines whether data specified by the writing request matches with a value of the “SR” that indicates the interrupt disabled status (Step S1508). When the execution determining unit 126 determines that the data specified by the writing request is different from the value of the “SR” (No at Step S1508), the operation-mode management circuit 1301 starts over from the process of setting “1” to the variable i as the initial value (Step S1501).

On the other hand, when it is determined that the data specified by the writing request matches with a value of the “SR” (Yes at Step S1508), it is considered that a proper execution of the entry field of the HV code is confirmed. Then, the processes after Step S613 shown in FIG. 6 will be performed.

In the system LSI 1300 according to the third embodiment, it can be confirmed that the interrupt by the other program is not performed by confirming an execution of the instruction fetch in the entry field of the HV code in the order of the instructions. With this scheme, it is possible to enhance the safety.

According to the third embodiment, the check of the instruction fetch is performed by a loop process (Steps S1502 to S1505); however, when the number of instructions is small, the loop process for checking the instruction fetch can be expanded. According to a modification of the third embodiment, an example is explained in which the loop process is expanded.

When actually designing a hardware circuit for checking the entry field, if the number of instructions of the entry field is small, the expansion of the loop makes the hardware implementation simple.

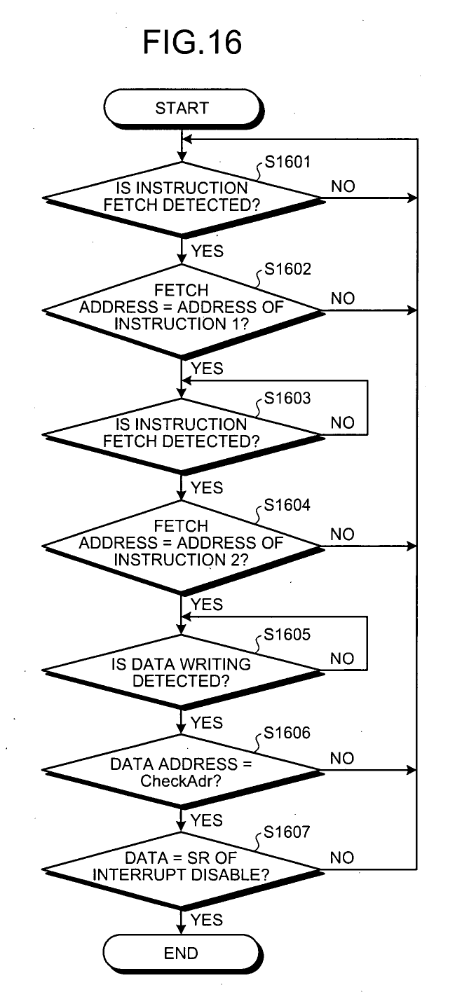

FIG. 16 is a flowchart of a processing procedure for expanding the loop of checking the instruction fetch of the processing procedure shown in FIG. 15 of the third embodiment with two times of checking the instruction fetch. In the flowchart shown in FIG. 16, a hardware implementation for performing an operation of the variable i is not necessary, allowing a circuit design as a simple state transition circuit, compared with FIG. 15.

As shown in FIG. 16, the fetch detecting unit 1311 monitors the sixth channel, and determines whether a instruction fetch request transmitted from the processor 101 is detected (Step S1601). This process is repeated until the instruction fetch request is detected.

When the fetch detecting unit 1311 detects the instruction fetch request (Yes at Step S1601), the fetch determining unit 1312 determines whether an address specified by the instruction fetch request is an address of the instruction 1 of the entry field (Step S1602). When the fetch determining unit 1312 determines that the address specified by the instruction fetch request is different from the address of the instruction 1 of the entry field (No at Step S1602), a process of determining whether the instruction fetch request is detected by the fetch detecting unit 1311 is performed again (Step S1601).

On the other hand, when it is determined that the address specified by the instruction fetch request matches with the address of the instruction 1 (Yes at Step S1602), the fetch detecting unit 1311 monitors the sixth channel, and determines whether a instruction fetch request transmitted from the processor 101 is detected (Step S1603). This process is repeated until the instruction fetch request is detected.

When the fetch detecting unit 1311 detects the instruction fetch request (Yes at Step S1603), the fetch determining unit 1312 determines whether an address specified by the instruction fetch request is an address of the instruction 2 of the entry field (Step S1604). When the fetch determining unit 1312 determines that the address specified by the instruction fetch request is different from the address of the instruction 2 of the entry field (No at Step S1604), a process of determining whether the instruction fetch request is detected by the fetch detecting unit 1311 is performed again (Step S1601).

On the other hand, when it is determined that the address specified by the instruction fetch request matches with the address of the instruction 2 (Yes at Step S1604), the instruction detecting unit 124 monitors the sixth channel, and determines whether a data writing request from the processor 101 is detected (Step S1605). When it is determined that the data writing request is not detected (No at Step S1605), the process is repeated until the data writing request is detected.

On the other hand, when the instruction detecting unit 124 detects the data writing request (Yes at Step S1605), the instruction detecting unit 124 determines whether an address specified by the data writing request matches with the “CheckAdr” (Step S1606). When it is determined that the address specified by the data writing request is different from the “CheckAdr” (No at Step S1606), a process of determining whether the instruction fetch request is detected by the fetch detecting unit 1311 is performed again (Step S1601).

On the other hand, when it is determined that the address specified by the data writing request matches with the “CheckAdr” (Yes at Step S1606), the execution determining unit 126 determines whether data specified by the writing request matches with a value of the “SR” that indicates the interrupt disabled status (Step S1607). When the execution determining unit 126 determines that the data specified by the writing request is different from the value of the “SR” (No at Step S1607), a process of determining whether the instruction fetch request is detected by the fetch detecting unit 1311 is performed again (Step S1601).

On the other hand, when it is determined that the data specified by the writing request matches with a value of the “SR” (Yes at Step S1607), the process ends considering that a proper execution of the entry field of the HV code is confirmed. Then, the processes after Step S613 shown in FIG. 6 will be performed.

Performing the above processing procedure, it is possible to make the hardware circuit simple. Furthermore, in the following embodiments, if the checking of the instruction fetch is processed by a loop, the loop process can be expanded as described above.

According to a fourth embodiment, it is confirmed that the instruction fetch of the entry field of the HV code is executed in the order of the instructions in the same manner as the third embodiment. A different point between the fourth embodiment and the third embodiment is that the entry field of the HV code is configured with a plurality of instructions for inhibiting the interrupt.

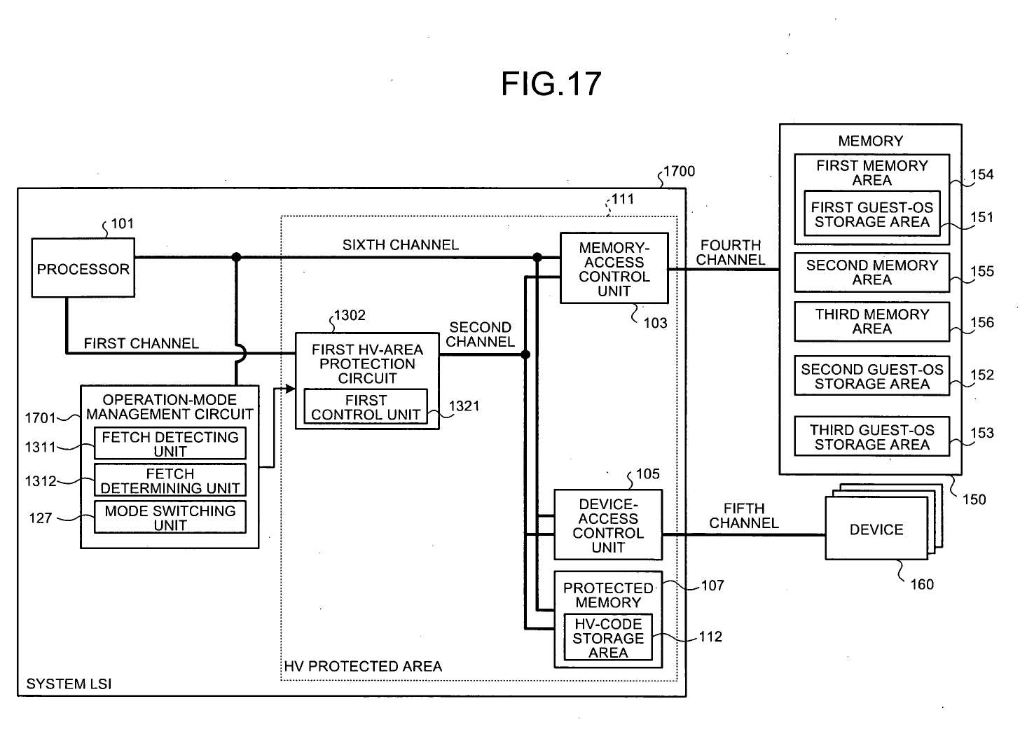

FIG. 17 is a block diagram illustrating a configuration of a system LSI 1700 according to the fourth embodiment. A difference between the system LSI 1700 and the system LSI 1300 according to the third embodiment is that the system LSI 1700 according to the fourth embodiment includes an operation-mode management circuit 1701 of which a process is different from that of the operation-mode management circuit 1301. An explanation about a common configuration with the system LSI 1300 according to the third embodiment from among the configuration of the system LSI 1700 according to the fourth embodiment will be omitted.

Furthermore, the HV code according to the fourth embodiment is the same as the HV code described in the third embodiment; and therefore, details on the HV code will not be explained. When the entry filed of such an HV code is configured with more than two instructions, there is a possibility that an arbitrary user code is executed while processing the HV code so that the interrupt disabled status is disguised.

The operation-mode management circuit 1701 is different from the operation-mode management circuit 1301 according to the third embodiment in that the instruction detecting unit 124 and the execution determining unit 126 are removed.

As a difference between the process of the operation-mode management circuit 1701 and the process of the operation-mode management circuit 1301, a processing procedure for monitoring the sixth channel by the fetch detecting unit 1311 of the operation-mode management circuit 1701 and confirming an appropriate execution of an entry field of the HV code is different. The processing procedure of confirming the appropriate execution of the entry field is explained below.

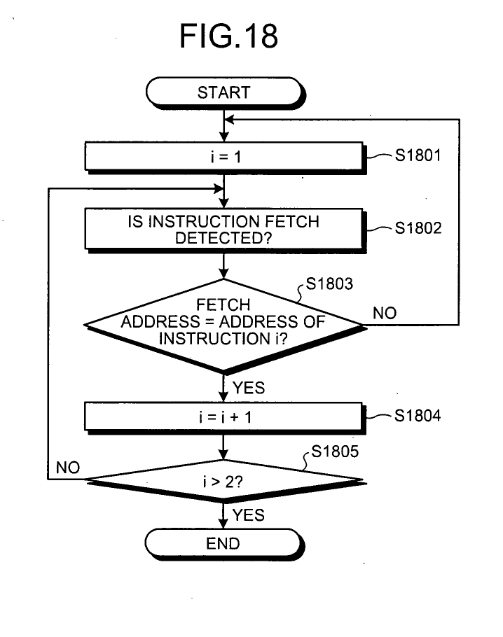

The processes from Step S1801 to Step S1805 shown in FIG. 18 are the same as the processes from Step S1501 to Step S1505 shown in FIG. 15; and therefore, an explanation for those processes will be omitted. When the processes to Step S1805 are performed, the processing procedure ends. Namely, in the processing procedure shown in FIG. 18, the process for detecting the data writing and confirming the interrupt disabled status performed after Step S1505 in FIG. 15 is not necessary.

In other words, according to the fourth embodiment, once the instructions 1 and 2 are fetched, the processor 101 becomes write-protected with an execution of the instructions. With this scheme, it is guaranteed that the processor 101 is in a write-protected status. In addition, it is possible to guarantee that a plurality of instructions of the entry field has been executed in an inseparable manner. Therefore, it is possible to secure the safety.

According to a fifth embodiment, an example is explained in which the interrupt is prevented by the time measurement as described in the first embodiment and a sequential execution of the instruction fetch of the entry field of the HV code is detected as described in the third embodiment. The HV code according to the fifth embodiment is the code shown in FIG. 3, which has the entry field for confirming the interrupt disabled status.

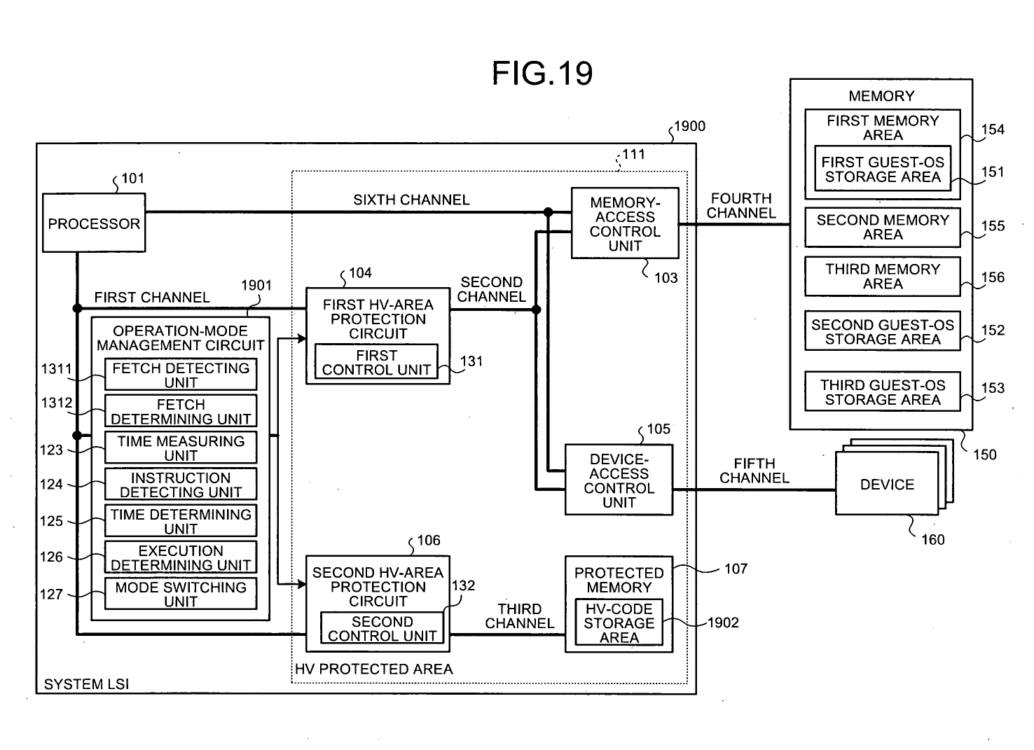

FIG. 19 is a block diagram illustrating a configuration of a system LSI 1900 according to the fifth embodiment. A difference between the system LSI 100 according to the first embodiment and the system LSI 1900 according to the fifth embodiment is that the system LSI 900 includes an operation-mode management circuit 1901 of which a process is different from that of the operation-mode management circuit 102 and an HV-code storage area 1902 having an HV code different from that stored in the HV-code storage area 112. An explanation about a common configuration with the system LSI 100 according to the first embodiment from among the configuration of the system LSI 1900 according to the fifth embodiment will be omitted.

The HV-code storage area 1902 stores therein the HV code shown in FIG. 3. As shown in FIG. 3, the entry field of the HV code is configured with a plurality of instructions, which is for confirming whether the processor 101 is in the interrupt disabled status.

In the system LSI 1900 according to the fifth embodiment, a plurality of interrupt inhibit schemes are combined because, when the number of instructions of the entry field is large, there is a possibility that the interrupt disabled status is disguised, for example, only with the measurement of the execution time for the entry field as described in the first embodiment.

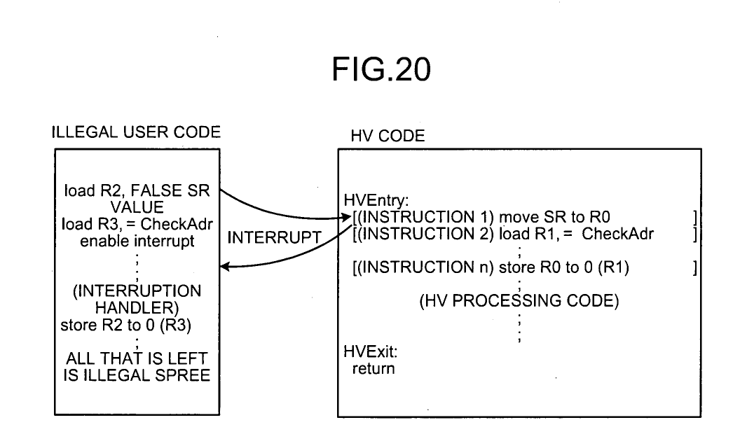

In the entry field of the HV code shown in FIG. 20, the value of the “SR” is written in the address “CheckAdr” by executing n pieces of instructions.

On the other hand, the illegal user code writes a value of a false “SR” to the general-purpose register “R2”, loads a value of the “CheckAdr” to an “R3”, enables the interrupt, and jumps to the instruction 1 of the entry field. Then, the illegal user code generates some sort of interrupt after executing the instruction 1, jumps to the interrupt handler of the illegal user code, and writes a value of the “R2” in the “CheckAdr” with the “R3” as a base register.

Namely, the illegal user code realizes the disguise of the interrupt disabled status by performing three processes: 1) execution of the instruction 1; 2) generation of the interrupt; and 3) writing the value of the false “SR” in the “CheckAdr”, after setting an illegal value in the general-purpose register in advance before calling the entry field of the HV code. Because the execution time for the three processes is shorter than the execution time for n pieces of instructions of the entry field of the HV code, it is impossible to detect an illegal interrupt only with the time measurement.

Furthermore, the system LSI 1900 according to the fifth embodiment has a configuration of the channels different from that of the system LSI 1300 according to the third embodiment; and therefore, all of the instruction fetches cannot be detected. In other words, in the system LSI 1900, there is a possibility fetching a instruction of the illegal user code when fetching the entry field of the HV code in the order of instructions.

Therefore, in the operation-mode management circuit 1901 of the system LSI 1900 according to the fifth embodiment, the time measurement described in the first embodiment and the detection of the sequential execution of the instruction fetch of the entry field of the HV code described in the third embodiment are performed.

Referring back to FIG. 19, the operation-mode management circuit 1901 is different from the operation-mode management circuit 102 according to the first embodiment in including the fetch detecting unit 1311 of which a process is different from that of the fetch detecting unit 121 and the fetch determining unit 1312 of which a process is different from that of the fetch determining unit 122. Explanations on the fetch detecting unit 1311 and the fetch determining unit 1312 will be omitted since they are described in the third embodiment.

A different point between the process of the system LSI 1900 and the process of the system LSI 100 is the processing procedure in which the fetch detecting unit 1311 of the operation-mode management circuit 1901 and the like monitors the first channel and confirms an appropriate execution of the entry field of the HV code. The processing procedure for confirming the appropriate execution of the entry field is explained below.

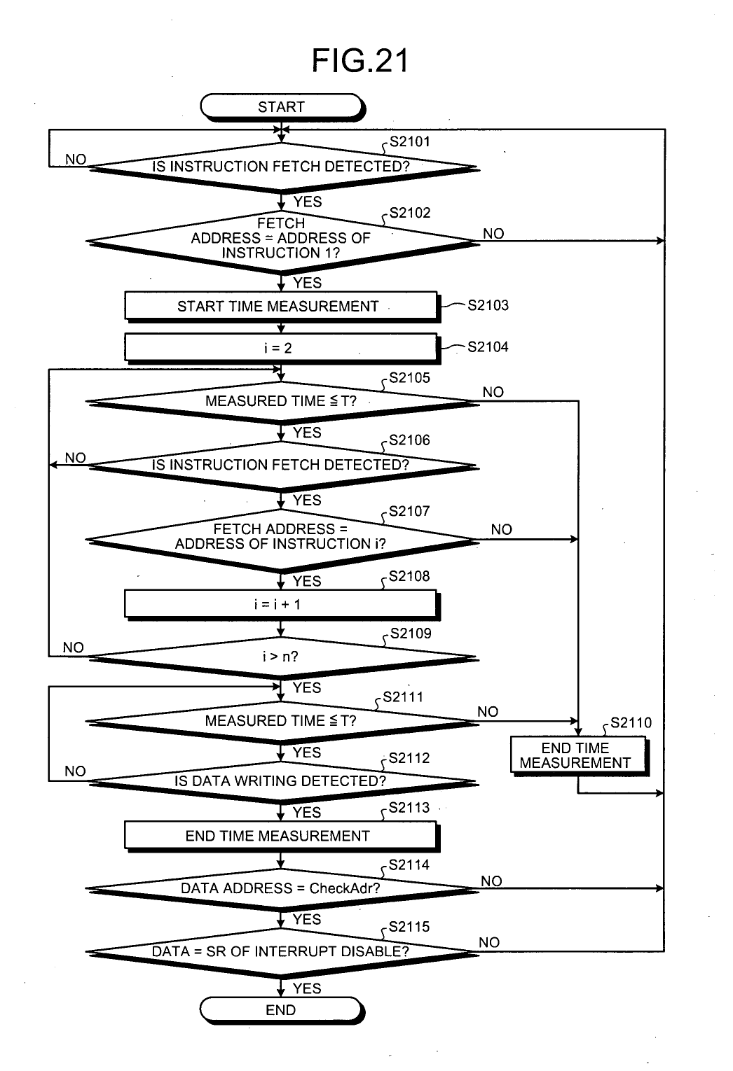

As shown in FIG. 21, the fetch detecting unit 1311 monitors the first channel, and determines whether the instruction fetch request transmitted form the processor 101 is detected (Step S2101). This process is repeated until the instruction fetch request is detected.

When the fetch detecting unit 1311 detects the instruction fetch request (Yes at Step S2101), the fetch determining unit 1312 determines whether an address specified by the instruction fetch request is the address of the instruction 1 of the entry field (Step S2102). When the fetch determining unit 1312 determines that the address specified by the instruction fetch request is different from the address of the instruction 1 of the entry field (No at Step S2102), a detection of the instruction fetch request by the fetch detecting unit 1311 is performed again (Step S2101).

On the other hand, when it is determined that the address specified by the instruction fetch request matches with the address of the instruction 1 (Yes at Step S2102), the time measuring unit 123 starts measuring time (Step S2103).

Subsequently, the operation-mode management circuit 1901 sets “2” to a variable i as an initial value for an entry check (Step S2104).

The time determining unit 125 determines whether a predetermined time T has passed since the time measuring unit 123 started measuring the time (Step S2105). The predetermined time T is a preset time required from the detection of the fetch of the instruction 1 until the execution of the instruction n.

When it is determined that the predetermined time T has passed by the time determining unit 125 (No at Step S2105), the time measuring unit 123 stops measuring the time (Step S2110), and the fetch detecting unit 1311 detects the instruction fetch again (Step S2101).

On the other hand, when it is determined that the predetermined time T has not passed by the time determining unit 125 (Yes at Step S2105), the fetch detecting unit 1311 monitors the first channel, and determines whether a instruction fetch request from the processor 101 is detected (Step S2106). This process is repeated until the instruction fetch request is detected.

When the fetch detecting unit 1311 detects the instruction fetch request (Yes at Step S2106), the fetch determining unit 1312 determines whether an address specified by the instruction fetch request is the address of the i-th instruction of the entry field (Step S2107). When the fetch determining unit 1312 determines that the address specified by the instruction fetch request is different from the address of the i-th instruction of the entry field (No at Step S2107), a detection of the instruction fetch request by the fetch detecting unit 1311 is performed again (Step S2101).

On the other hand, when it is determined that the address specified by the instruction fetch request matches with the address of the i-th instruction (Yes at Step S2107), the operation-mode management circuit 1901 adds “1” to the variable i (Step S2108). Then, the operation-mode management circuit 1901 determines whether the variable i is larger than “n” (Step S2109). Namely, the above processes are repeated by the number of instructions included in the entry field of the HV code.

When the operation-mode management circuit 1901 determines that the variable i is not larger than “n” (No at Step S2109), the time determining unit 125 determines whether a predetermined time T has passed since the time measuring unit 123 started measuring the time again (Step S2105).

On the other hand, when the operation-mode management circuit 1301 determines that the variable i is larger than “2” (Yes at Step S1505), the time determining unit 125 determines whether the predetermined time T has passed since the time measuring unit 123 started measuring the time (Step S2111).

When it is determined that the predetermined time T has passed (No at Step S2111), the time measuring unit 123 stops measuring the time (Step S2110), and the fetch detecting unit 1311 detects the instruction fetch again (Step S2101).

On the other hand, when it is determined that the predetermined time T has not passed by the time determining unit 125 (Yes at Step S2111), the instruction detecting unit 124 monitors the first channel, and determines whether a data writing request from the processor 101 is detected (Step S2112). When it is determined that the data writing request is not detected (No at Step S2112), the process starts over from the determination whether the predetermined time T has passed by the time determining unit 125 (Step S2111).

When the instruction detecting unit 124 detects the data writing request (Yes at Step S2112), the time measuring unit 123 stops measuring time (Step S2113). Then, the instruction detecting unit 124 determines whether an address specified by the data writing request matches with the “CheckAdr” (Step S2114). When it is determined that the address specified by the data writing request is different from the “CheckAdr” (No at Step S2114), a detection of the instruction fetch request by the fetch detecting unit 121 is performed again (Step S2101).

On the other hand, when it is determined that the address specified by the data writing request matches with the “CheckAdr” (Yes at Step S2114), the execution determining unit 126 determines whether data specified by the writing request matches with a value of the “SR” that indicates the interrupt disabled status (Step S2115). When it is determined that the data specified by the writing request is different from the value of the “SR” (No at Step S2115), a detection of the instruction fetch request by the fetch detecting unit 121 is performed again (Step S2101).

On the other hand, when it is determined that the data specified by the writing request matches with the value of the “SR” (Yes at Step S2115), it is considered that a proper execution of the entry field of the HV code is confirmed. Then, the processes after Step S613 shown in FIG. 6 will be performed.

In the system LSI 1900 according to the fifth embodiment, the interrupt prevention by the time measurement as described in the first embodiment and a process of detecting a sequential execution of the instruction fetch of the entry field of the HV code as described in the third embodiment are combined. With this scheme, it is possible to detect an illegal interrupt that is hard to detect only with the time measurement when there are a number of instructions in the entry field of the HV code because of its short execution time. Therefore, it is possible to enhance the safety.

In a sixth embodiment, an example is explained in which the interrupt is prevented by the time measurement as described in the second embodiment and a sequential execution of the instruction fetch of the entry field of the HV code is detected as described in the third embodiment. The HV code according to the sixth embodiment is the code shown in FIG. 11, which has the entry field for setting the interrupt disabled status.

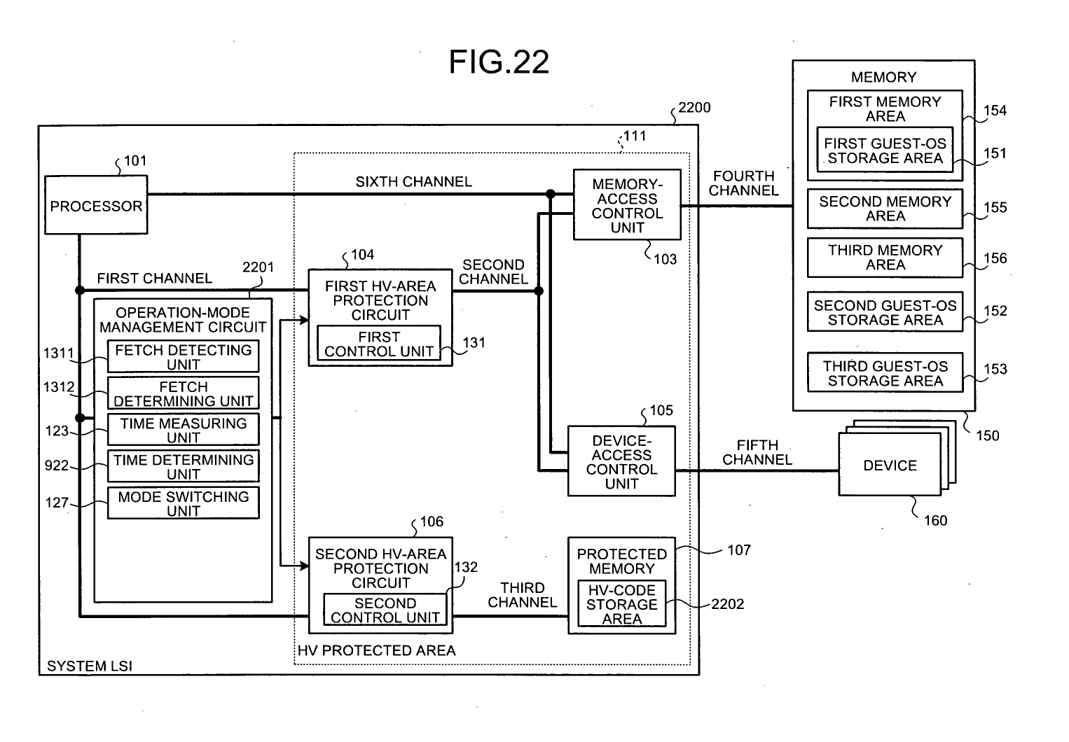

FIG. 22 is a block diagram illustrating a configuration of a system LSI 2200 according to the sixth embodiment. A difference between the system LSI 100 according to the first embodiment and the system LSI 2200 according to the sixth embodiment is that the system LSI 2200 includes an operation-mode management circuit 2201 of which a process is different from that of the operation-mode management circuit 901 and an HV-code storage area 2202 having an HV code different from that stored in the HV-code storage area 911. An explanation about a common configuration with the system LSI 100 according to the first embodiment from among the configuration of the system LSI 2200 according to the sixth embodiment will be omitted.

The HV-code storage area 2202 stores therein the HV code shown in FIG. 11. As shown in FIG. 3, the entry field of the HV code is configured with a plurality of instructions, for setting the processor 101 in the interrupt disabled status.

A difference between the operation-mode management circuit 2201 and the operation-mode management circuit 901 according to the second embodiment is that the operation-mode management circuit 2201 includes the fetch detecting unit 1311 of which a process is different from that of the fetch detecting unit 121 and the fetch determining unit 1312 of which a process is different from that of the fetch determining unit 122. Explanations on the fetch detecting unit 1311 and the fetch determining unit 1312 will be omitted since they are described in the third embodiment.

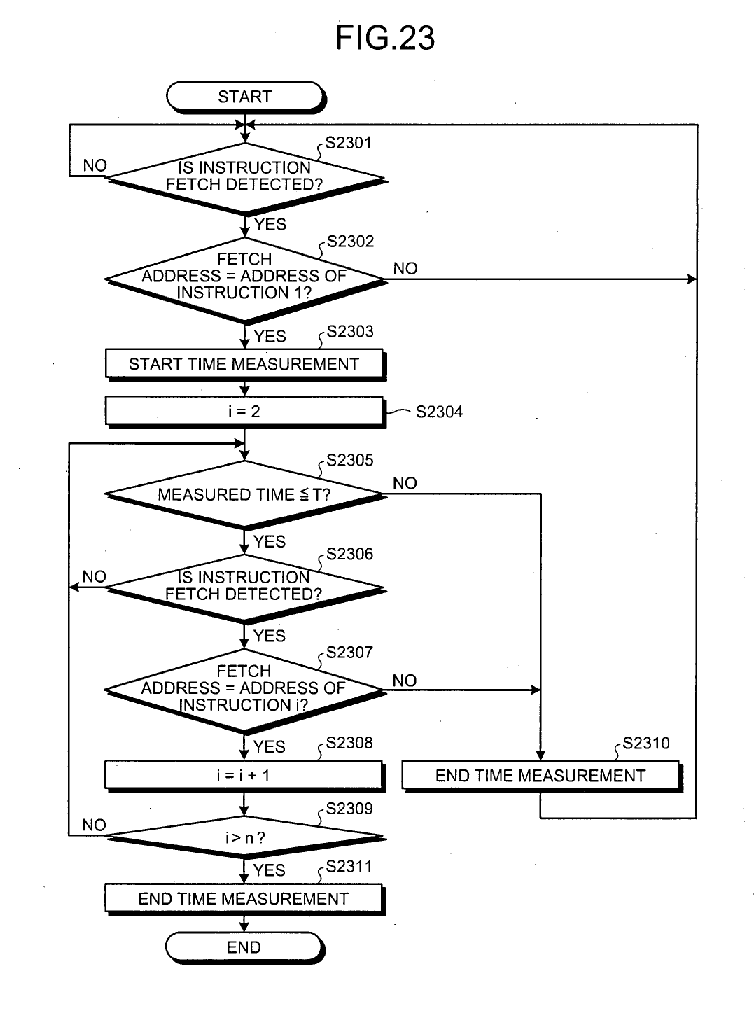

The processes from Step S2301 to Step S2310 shown in FIG. 23 are the same as the processes from Step S2101 to Step S2110 shown in FIG. 21; and therefore, an explanation for those processes will be omitted. When the variable i becomes larger than the number of instructions “n” of the entry field at Step S2309 (Yes at Step S2309), the time measuring unit 123 stops measuring the time, considering that the fetch of all of the instructions is detected (Step S2311), and the process ends. Namely, in the processing procedure shown in FIG. 23, the process for detecting the data writing and confirming the interrupt disabled status performed after Step S2111 in FIG. 21 is not necessary.

In other words, according to the sixth embodiment, once n pieces of instructions are fetched in the order of the instructions, the processor 101 becomes write-protected with an execution of the instructions. With this scheme, it is guaranteed that the processor 101 is in a write-protected status. In addition, it is possible to guarantee that a plurality of instructions of the entry field has been executed in an inseparable manner. Therefore, it is possible to secure the safety.

In the system LSI 2200 according to the sixth embodiment, the interrupt prevention by the time measurement as described in the first embodiment and a process of detecting a sequential execution of the instruction fetch of the entry field of the HV code as described in the third embodiment are combined. With this scheme, it is possible to detect an illegal interrupt that is hard to detect only with the time measurement when there are a number of instructions in the entry field of the HV code because of its short execution time. Therefore, it is possible to enhance the safety.

The present invention is not limited to the above embodiments, but various modifications can be made as described below.

According to the first to the sixth embodiments, a case is explained in which the instruction fetch unit of the processor 101 is a single instruction. However, the above embodiments do not limit the instruction fetch unit to the single instruction. In a first modification, the instruction fetch unit of two instructions is explained.

In a system LSI according to the first modification, the processor performs a instruction fetch for every two instructions. A method of confirming whether the process is in the interrupt disabled status at the time of the instruction fetch is the same as those in the above embodiments.

When the instruction fetch unit is a plurality of instructions, there is a possibility that the interrupt disabled status is disguised depending on an arrangement of the instructions in the entry field of the HV code. Following is an explanation on an arrangement of the instructions with which the interrupt disabled status is disguised in the entry field of the HV code.

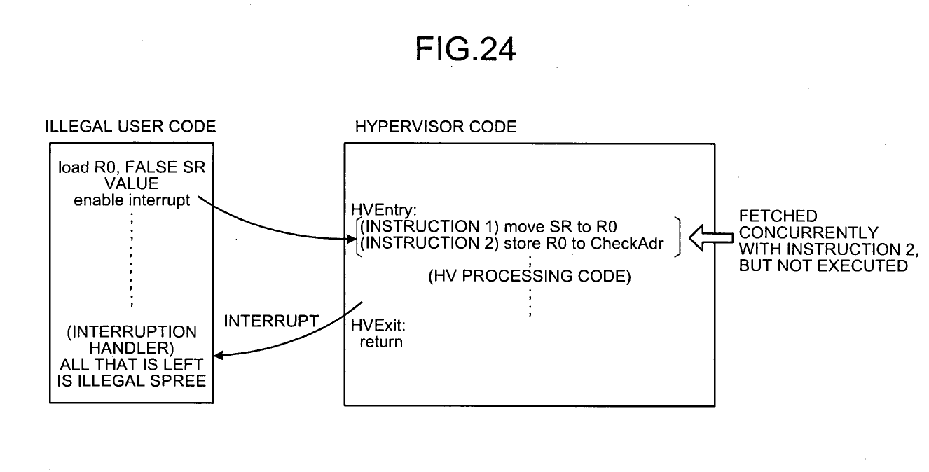

In the example shown in FIG. 24, the entry field of the HV code is configured with two instructions, and the instruction fetch unit of the processor is every two instructions. When the instruction 1 of the entry field is arranged at an address boundary of the instruction fetch unit, the two instructions of the entry field are read out at the same time with a single time of a instruction fetch.

Therefore, if the confirmation of the instruction fetch is performed as described in the third and the fourth embodiments, the confirmation of the instruction fetch is performed only once. In this case, a disguise of the interrupt disabled status as follows can be considered.

As shown in FIG. 24, an illegal user code loads a value of a false “SR” to the “R0”, enables the interrupt, and then, jumps to the instruction 2 of the entry field. At this time, because the instruction fetch is performed with two instruction unit, the instruction fetch is issued with respect to the instruction 1. Then, the operation-mode management circuit determines that the entry field of the HV code is appropriately called. In spite that the processor is in an interrupt enabled status, the instruction 2 writes the value of the false “SR” indicating the interrupt disable to the address “CheckAdr”.

This causes the HV code to be executed in the interrupt enabled status. When there is an interrupt by an illegal user code at this time, the process jumps to the interrupt handler of the illegal use code with the operation mode set in the HV mode.

For this reason, the HV-code storage area of the system LSI according to the present modification stores therein a following HV code.

When storing the HV code in the HV-code storage area, to prevent the above disguise, the top instruction of the original entry field is arranged at the last of the first instruction fetch unit.

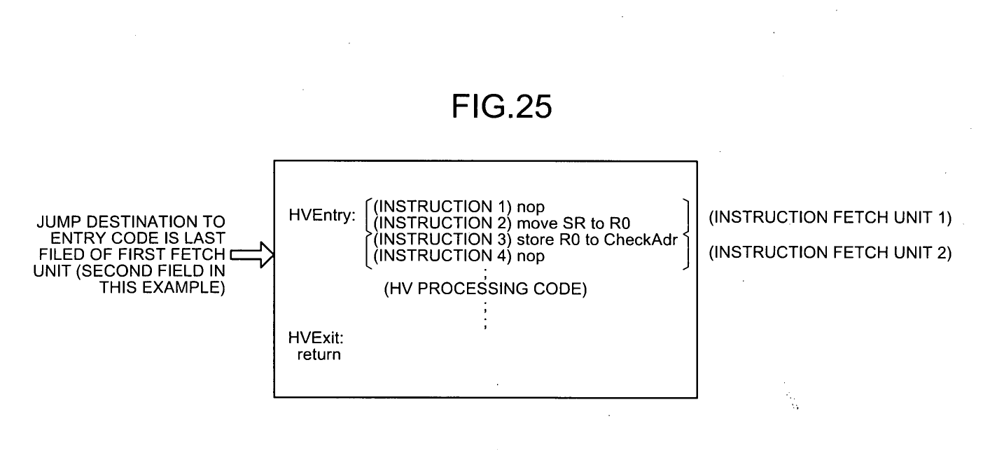

In the HV code shown in FIG. 25, the instruction 1 and a instruction 3 are arranged at a boundary of two instructions in the entry field. With this arrangement, the instructions 1 and 2 and the instructions 3 and 4 are fetched at the same time with a fetch request from the processor.

To prevent the disguise described above, the “move” instruction that is the first instruction of the original entry field is arranged at the last of the first instruction fetch unit, i.e., the second instruction. Then, the “store” instruction that is the second instruction of the original entry field is arranged at the first of the second instruction fetch, i.e., the third instruction. When an illegal user code tries to disguise the interrupt disabled status, a fetch of the instruction fetch unit 2 is requested without requesting the instruction fetch unit 1, the operation-mode management circuit can make a determination that an abnormal fetch request is performed.

In addition, even when the instruction fetch unit is configured with a plurality of instructions, the processes explained in the above embodiments are applicable as virtually they are.

Furthermore, in the above embodiments, it can also be applied to a case where the instruction fetch unit is a plurality of instructions by replacing the instruction (for example, n pieces of instructions) with the instruction fetch unit (for example, n pieces of instruction fetch units) and an expression saying the variable i is n-th instruction in the entry field with an expression saying the variable i is n-th instruction fetch unit in the entry field.

According to the first to the sixth embodiments, a case is explained in which the processor 101 does not have a prefetch function. However, it is not limited to the processor without having the prefetch function. According to a second modification, a case of a processor having the prefetch function is explained.

In a case where the processor included in the system LSI has a prefetch function, during an execution of a specific instruction, a instruction fetch for subsequent instructions is performed. Therefore, even if a instruction fetch for a specific instruction is detected, it does not always mean that the instruction is executed.

In the entry field of the HV code shown in FIG. 2, the interrupt disabled status is guaranteed by writing the value of the “SR” to the “CheckAdr” at the instruction 2. However, when the processor has the prefetch function, the instruction 2 is prefetched during the execution of the instruction 1.

Such cases can be solved by investigating a range of instructions for which the instruction fetch request is performed by the prefetch when the instructions are appropriately executed until the last instruction that guarantees the interrupt disable of the entry field (hereinafter, “a guarantee instruction”), and confirming the instruction fetch including the prefetch range at the time of confirming the instruction fetch of the entry field.

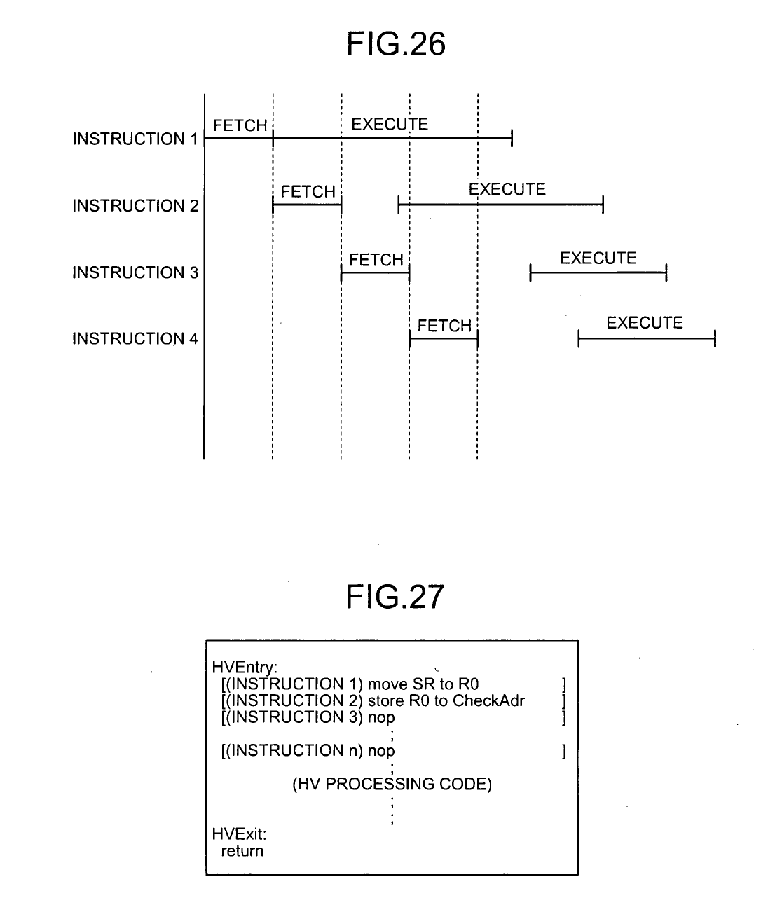

As shown in FIG. 26, for the instructions after the instruction 2, the execution is performed after a predetermined time passes. When the entry filed needs to executed two instructions, the instruction fetch performed at the time of executing the second instruction can also be confirmed. In the example shown in FIG. 26, the execution of the instruction 2 is guaranteed by confirming the instruction fetch for a instruction 4.

To adapt the processes performed in the above embodiments to the processor with the prefetch function, it is necessary to include a instruction for the prefetch range in the entry field as well as the instructions included in the entry field of the HV code including the guarantee instruction.

A method of adapting the prefetch function in a case of the number of instructions of the instruction fetch unit=1 is explained below. The HV code shown in FIG. 27 includes an entry field for checking the interrupt disabled status with two instructions in nature, similar to the HV code shown in FIG. 3.

In the example shown in FIG. 27, after a fetch request for the instructions 1 and 2 that configures the original entry field, subsequent instructions including the instruction n are prefetched until a writing is performed to the address “CheckAdr” with the execution of the instruction 2. The number of instructions “n” depends on a performance of the processor. In the example shown in FIG. 27, a “nop” instruction (instruction for doing nothing) is arranged to the instruction n.

Although the “nop” instruction is arranged in the prefetch range for the explanation in the present modification, the main body of the HV code can also be arranged instead.

When applying the processes described in the first, the second, and the third embodiments, the instruction n to be prefetched is desired not to be prefetched at the time of the execution of the instruction 1 but to be prefetched until a data writing to the “CheckAdr” since the start of the execution of the instruction 2.

Although it is different from the HV code according to the present modification, when applying the processes described in the second, the fourth, and the sixth embodiments, the instruction n to be prefetched is desired to be prefetched during the execution of the instruction 2.

In this manner, by providing the instructions with the prefetch range in the entry field of the HV code, it is possible to apply the processing procedures described in the above embodiments to the processor with the prefetch function.

In a similar manner, even if a instruction fetch unit is configured with a plurality of instructions, it can be applied to the processor with the prefetch function.

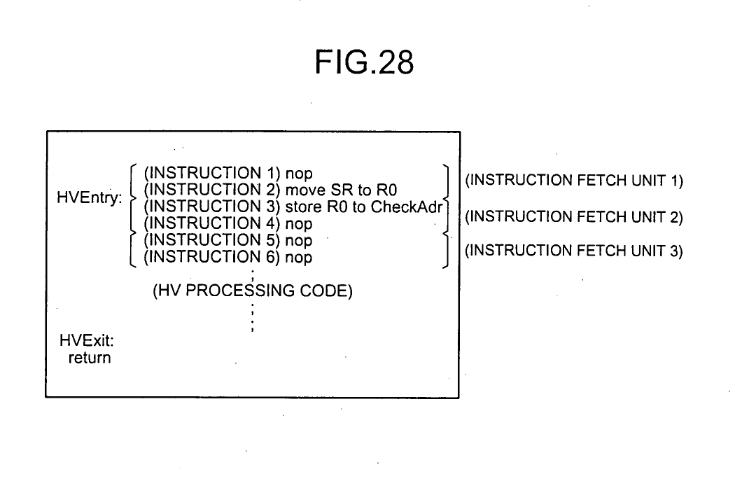

The HV code shown in FIG. 28 includes an entry field in which the instruction fetch unit is for every two instructions, similar to that shown in FIG. 25. In the example shown in FIG. 28, a fetch request for the instructions 2 and 3 that configure the original entry field is performed, and instructions 5 and 6 are prefetched until a data writing is performed to the address “CheckAdr” by executing the instruction 3.

As described above, the processing procedures described in the above embodiments can be applied to a system LSI including a processor with a prefetch function by configuring the entry field including a prefetch range.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a processor;
a first storing unit configured to store a first software that causes the processor to access a first access range;
a second storing unit configured to store a second software that causes the processor to access a second access range that is narrower than the first access range;
a channel configured to connect the first storing unit and the processor, and perform a communication of data required for the processor to execute the first software;
a fetch detecting unit configured to detect a fetch to a storage address of the first storage unit which stores a first instruction executed at first within a plurality of instructions that is included in the first software and executed when the processor starts the first software via the channel;
an execution detecting unit configured to detect that a specific instruction within the plurality of instructions is executed by the processor via the channel;
a time determining unit configured to determine whether a predetermined time has passed since the fetch detecting unit detects the fetch to the storage address until the execution detecting unit detects the execution of the specific instruction, when the processor is executing the first software;
an execution determining unit configured to determine whether an interrupt to the processor is prohibited based on a result of executing the specific instruction by the processor, when the time determining unit determines that the predetermined time has not passed; and
a control unit configured to release an access to the first access range to the processor, when the execution determining unit determines that an interrupt to the processor is prohibited.

2. The apparatus according to claim 1, wherein
the processor performs a fetch by a plurality of instructions, and
the fetch detecting unit detects a fetch of a heading address by the plurality of instructions including the first instruction as the storage address.

3. The apparatus according to claim 2, wherein the first storing unit arranges the first instruction within the plurality of instructions at the end of the plurality of instructions fetched by the processor.

4. The apparatus according to claim 1, wherein
the processor has a prefetch function performing a fetch of a instruction before execution, and
the first storing unit constitutes the plurality of instructions with number of fetch targets of the processor at a timing when the processor executes a instruction to confirm a writing protected status.

5. An information processing apparatus comprising:
a processor;
a first storing unit configured to store a first software that causes the processor to access a first access range;
a second storing unit configured to store a second software that causes the processor to access a second access range that is narrower than the first access range;
a channel configured to connect the first storing unit and the processor, and perform a communication of data required for the processor to execute the first software;
a first fetch detecting unit configured to detect a fetch to a first storage address of the first storage unit which stores a first instruction executed at first within a plurality of instructions that is included in the first software and executed when the processor starts the first software via the channel;
a second fetch detecting unit configured to detect a fetch to a second storage address of the first storage unit which stores a specific instruction within a plurality of instructions that is included in the first software and executed when the processor starts the first software via the channel;
a time determining unit configured to determine whether a predetermined time has passed since the first fetch detecting unit detects the fetch to the first storage address until the second fetch detecting unit detects the fetch to the second storage address, when the processor is executing the first software; and
a control unit configured to release an access to the first access range to the processor, when the time determining unit determines that the predetermined time has not passed.

6. The apparatus according to claim 5, wherein
the processor performs a fetch by a plurality of instructions, and
the first fetch detecting unit detects a fetch of a heading address by the plurality of instructions including the first instruction as the first storage address.

7. The apparatus according to claim 6, wherein the first storing unit arranges the first instruction within the plurality of instructions at the end of the plurality of instructions fetched by the processor.

8. The apparatus according to claim 5, wherein
the processor has a prefetch function performing a fetch of a instruction before execution, and
the first storing unit constitutes the plurality of instructions with number of fetch targets of the processor at a timing when the processor executes a instruction to confirm a writing protected status.

9. An information processing apparatus comprising:
a processor;
a first storing unit configured to store a first software that causes the processor to access a first access range;
a second storing unit configured to store a second software that causes the processor to access a second access range that is narrower than the first access range;
a channel configured to connect the first storing unit and the processor, and perform a communication of data required for the processor to execute the first software;
a fetch detecting unit configured to detect a fetch to a plurality of instructions that is included in the first software and executed when the processor starts the first software via the channel;
a fetch determining unit configured to determine whether a fetch to each storage address which stores each instruction constituting the plurality of instructions is performed in an order of the instructions from an address of a detected fetch destination, when the processor is executing the first software;
an execution detecting unit configured to detect that a specific instruction within the plurality of instructions is executed by the processor, when the fetch determining unit determines that the fetch of the plurality of instructions has performed in the order of the instructions;
a determining unit configured to determine whether the processor is in an interrupt disabled status from a result of executing the plurality of instructions detected; and
a control unit configured to release an access to the first access range to the processor, when the execution determining unit determines that an interrupt to the processor is prohibited.

10. The apparatus according to claim 9, wherein
the processor performs a fetch by a plurality of instructions, and
the fetch detecting unit detects a fetch of a heading address by the plurality of instructions including the first instruction as the storage address.

11. The apparatus according to claim 10, wherein the first storing unit arranges the first instruction within the plurality of instructions at the end of the plurality of instructions fetched by the processor.

12. The apparatus according to claim 9, wherein
the processor has a prefetch function performing a fetch of a instruction before execution, and
the first storing unit constitutes the plurality of instructions with number of fetch targets of the processor at a timing when the processor executes a instruction to confirm a writing protected status.

13. An information processing apparatus comprising:
a processor;
a first storing unit configured to store a first software that causes the processor to access a first access range;
a second storing unit configured to store a second software that causes the processor to access a second access range that is narrower than the first access range;
a channel configured to connect the first storing unit and the processor, and perform a communication of data required for the processor to execute the first software;
a fetch detecting unit configured to detect a fetch to a plurality of instructions that is included in the first software and executed when the processor starts the first software via the channel;
a fetch determining unit configured to determine whether a fetch to each storage address which stores each instruction constituting the plurality of instructions is performed in an order of the instructions from an address of a detected fetch destination, when the processor is executing the first software; and
a control unit configured to release an access to the first access range to the processor, when the fetch determining unit determines that the fetch of the plurality of instructions has performed in the order of the instructions.

14. The apparatus according to claim 13, wherein
the processor performs a fetch by a plurality of instructions, and
the fetch detecting unit detects a fetch of a heading address by the plurality of instructions including the first instruction as the storage address.

15. The apparatus according to claim 14, wherein the first storing unit arranges the first instruction within the plurality of instructions at the end of the plurality of instructions fetched by the processor.

16. The apparatus according to claim 13, wherein
the processor has a prefetch function performing a fetch of a instruction before execution, and
the first storing unit constitutes the plurality of instructions with number of fetch targets of the processor at a timing when the processor executes a instruction to confirm a writing protected status.
